(19) United States
(12) Patent Application Publication
(10) Pub. No.: US 2025/0350442 A1
(43) Pub. Date: Nov. 13, 2025

(54) TECHNIQUES FOR RESOLVING MULTIPLE COLLISIONS IN SUB-BAND FULL-DUPLEX (SBFD) SYMBOLS

(71) Applicant: QUALCOMM Incorporated, San Diego, CA (US)

(72) Inventors: Muhammad Sayed Khairy ABDELGHAFFAR, San Jose, CA (US); Abdelrahman Mohamed IBRAHIM, San Diego, CA (US); Ahmed Attia ABOTABL, San Diego, CA (US)

(21) Appl. No.: 19/201,424

(22) Filed: May 7, 2025

Related U.S. Application Data
(60) Provisional application No. 63/645,270, filed on May 10, 2024.

(51) Int. Cl. H04L 5/16; H04L 5/00

(52) U.S. Cl. CPC H04L 5/16; H04L 5/0098

(57) ABSTRACT

Methods, systems, and devices for wireless communications are described. In some wireless communications systems, a half-duplex user equipment (UE) may receive a configuration message indicating one or more sub-band full-duplex (SBFD) symbols for a network entity. Additionally, the UE may receive one or more control messages scheduling, during an SBFD symbol, multiple messages including one or more uplink messages, one or more downlink messages, or both, where the multiple messages result in multiple SBFD collisions within the SBFD symbol and where the multiple SBFD collisions are associated with one or more SBFD collision types. Thus, the UE may communicate, via the SBFD symbol, at least a subset of the multiple messages based on resolving the set of multiple SBFD collisions in accordance with an SBFD collision type priority order, one or more SBFD collision rules, or both.

### CROSS REFERENCES

The present Application for Patent claims benefit of U.S. Provisional Patent Application No. 63/645,270 by ABDELGHAFFAR et al., entitled “TECHNIQUES FOR RESOLVING MULTIPLE COLLISIONS IN SUB-BAND FULL-DUPLEX (SBFD) SYMBOLS,” filed May 10, 2024, assigned to the assignee hereof, and expressly incorporated herein.

### FIELD OF TECHNOLOGY

The following relates to wireless communications, including techniques for resolving multiple collisions in sub-band full-duplex (SBFD) symbols.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a half-duplex user equipment (UE) is described. The method may include receiving a configuration message indicating one or more sub-band full-duplex (SBFD) symbols for a network entity, where each SBFD symbol of the one or more SBFD symbols includes one or more uplink sub-bands and one or more downlink sub-bands, receiving one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol, and communicating, via the SBFD symbol, at least a fifth subset of the set of multiple messages based on resolving the set of multiple SBFD collisions in accordance with an SBFD collision type priority order.

A half-duplex UE for wireless communications is described. The half-duplex UE may include one or more memories storing processor executable code, and one or more processors coupled with the one or more memories. The one or more processors may individually or collectively be operable to execute the code to cause the half-duplex UE to receive a configuration message indicating one or more SBFD symbols for a network entity, where each SBFD symbol of the one or more SBFD symbols includes one or more uplink sub-bands and one or more downlink sub-bands, receive one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol, and communicate, via the SBFD symbol, at least a fifth subset of the set of multiple messages based on resolving the set of multiple SBFD collisions in accordance with an SBFD collision type priority order.

Another half-duplex UE for wireless communications is described. The half-duplex UE may include means for receiving a configuration message indicating one or more SBFD symbols for a network entity, where each SBFD symbol of the one or more SBFD symbols includes one or more uplink sub-bands and one or more downlink sub-bands, means for receiving one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol, and means for communicating, via the SBFD symbol, at least a fifth subset of the set of multiple messages based on resolving the set of multiple SBFD collisions in accordance with an SBFD collision type priority order.

A non-transitory computer-readable medium storing code for wireless communications is described. The code may include instructions executable by one or more processors to receive a configuration message indicating one or more SBFD symbols for a network entity, where each SBFD symbol of the one or more SBFD symbols includes one or more uplink sub-bands and one or more downlink sub-bands, receive one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol, and communicate, via the SBFD symbol, at least a fifth subset of the set of multiple messages based on resolving the set of multiple SBFD collisions in accordance with an SBFD collision type priority order.

Some examples of the method, half duplex UEs, and non-transitory computer-readable medium described herein may further include operations, features, means, or instructions for resolving, at a first time, one or more first SBFD collisions from the set of multiple SBFD collisions in accordance with the SBFD collision type priority order based on the one or more first SBFD collisions being associated with the first SBFD collision type, where communicating the at least a fifth subset of the set of multiple messages may be based on resolving the one or more first SBFD collisions.

In some examples of the method, half duplex UEs, and non-transitory computer-readable medium described herein, resolving the one or more first SBFD collisions from the set of multiple SBFD collisions may include operations, features, means, or instructions for refraining from transmitting at least a portion of the first uplink message via the SBFD symbol based on the at least portion of the first uplink message overlapping with the one or more resources outside of the one or more uplink sub-bands, where the at least fifth subset of the set of multiple messages excludes the at least portion of the first uplink message.

In some examples of the method, half duplex UEs, and non-transitory computer-readable medium described herein, resolving the one or more first SBFD collisions from the set of multiple SBFD collisions may include operations, features, means, or instructions for refraining from receiving at least a portion of the first downlink message via the SBFD symbol based on the at least portion of the first downlink message overlapping with the one or more resources outside of the one or more downlink sub-bands, where the at least fifth subset of the set of multiple messages excludes the at least portion of the first downlink message.

Some examples of the method, half duplex UEs, and non-transitory computer-readable medium described herein may further include operations, features, means, or instructions for resolving, at a second time subsequent to the first time, one or more second SBFD collisions from the set of multiple SBFD collisions in accordance with the SBFD collision type priority order based on the one or more second SBFD collisions being associated with the second SBFD collision type and resolving, at a third time subsequent to the second time, one or more third SBFD collisions from the set of multiple SBFD collisions in accordance with the SBFD collision type priority order based on the one or more third SBFD collisions being associated with the third SBFD collision type, where communicating the at least a fifth subset of the set of multiple messages may be based on resolving the one or more second SBFD collisions and the one or more third SBFD collisions.

In some examples of the method, half duplex UEs, and non-transitory computer-readable medium described herein, resolving the one or more second SBFD collisions may include operations, features, means, or instructions for refraining from transmitting the first uplink message based on the second uplink message being associated with a higher priority than the second uplink message and multiplexing the first uplink message into the second uplink message based on the second uplink message being associated with a higher priority than the second uplink message.

In some examples of the method, half duplex UEs, and non-transitory computer-readable medium described herein, the one or more third SBFD collisions may be based on a first uplink message of the one or more uplink messages at least partially overlapping with a first downlink message of the one or more downlink messages and a set of collision symbols associated with the first uplink message may be based on one or more time domain resources allocated for the first uplink message that overlap with the first downlink message, all symbols associated with the first uplink message, a quantity of symbols prior to a transmission time of the first uplink message, or any combination thereof.

Some examples of the method, half duplex UEs, and non-transitory computer-readable medium described herein may further include operations, features, means, or instructions for resolving, at a second time subsequent to the first time, one or more second SBFD collisions from the set of multiple SBFD collisions in accordance with the SBFD collision type priority order based on the one or more second SBFD collisions being associated with the third SBFD collision type and resolving, at a third time subsequent to the second time, one or more third SBFD collisions from the set of multiple SBFD collisions in accordance with the SBFD collision type priority order based on the one or more third SBFD collisions being associated with the second SBFD collision type, where communicating the at least a fifth subset of the set of multiple messages may be based on resolving the one or more second SBFD collisions and the one or more third SBFD collisions.

In some examples of the method, half duplex UEs, and non-transitory computer-readable medium described herein, resolving the one or more third SBFD collisions may include operations, features, means, or instructions for refraining from transmitting the first uplink message based on the second uplink message being associated with a higher priority than the second uplink message and multiplexing the first uplink message into the second uplink message based on the second uplink message being associated with a higher priority than the second uplink message.

Some examples of the method, half duplex UEs, and non-transitory computer-readable medium described herein may further include operations, features, means, or instructions for receiving a second control message indicating the second transmission direction associated with the SBFD symbol.

Some examples of the method, half duplex UEs, and non-transitory computer-readable medium described herein may further include operations, features, means, or instructions for resolving, at a first time, one or more first SBFD collisions from the set of multiple SBFD collisions based on the one or more first SBFD collisions being associated with the fourth SBFD collision type and resolving, at a second time subsequent to the first time, one or more second SBFD collisions from the set of multiple SBFD collisions based on the one or more second SBFD collisions being associated with the first SBFD collision type, where communicating the at least a fifth subset of the set of multiple messages may be based on resolving the one or more first SBFD collisions and the one or more second SBFD collisions.

In some examples of the method, half duplex UEs, and non-transitory computer-readable medium described herein, resolving the one or more first SBFD collisions may include operations, features, means, or instructions for refraining from receiving the one or more downlink messages based on the second transmission direction being uplink and refraining from transmitting the one or more uplink messages based on the second transmission direction being downlink.

In some examples of the method, half duplex UEs, and non-transitory computer-readable medium described herein, resolving the one or more second SBFD collisions may include operations, features, means, or instructions for refraining from transmitting at least a portion of the one or more uplink messages via the SBFD symbol based on the second transmission direction being uplink, where the at least portion of the one or more uplink messages overlaps with the one or more downlink sub-bands, and where the at least fifth subset of the set of multiple messages excludes the at least portion of the one or more uplink messages and refraining from receiving at least a portion of the one or more downlink messages via the SBFD symbol based on the second transmission direction being downlink, where the at least portion of the one or more downlink messages overlaps with the one or more uplink sub-bands, and where the at least fifth subset of the set of multiple messages excludes the at least portion of the one or more downlink messages.

In some examples of the method, half duplex UEs, and non-transitory computer-readable medium described herein, the second transmission direction may be uplink and the method, apparatuses, and non-transitory computer-readable medium may include further operations, features, means, or instructions for resolving, at a third time subsequent to the second time, one or more third SBFD collisions from the set of multiple SBFD collisions based on the one or more third SBFD collisions being associated with the second SBFD collision type, where communicating the at least a fifth subset of the set of multiple messages may be based on resolving the one or more third SBFD collisions.

In some examples of the method, half duplex UEs, and non-transitory computer-readable medium described herein, resolving the one or more third SBFD collisions may include operations, features, means, or instructions for refraining from transmitting the first uplink message based on the second uplink message being associated with a higher priority than the second uplink message and multiplexing the first uplink message into the second uplink message based on the second uplink message being associated with a higher priority than the second uplink message.

In some examples of the method, half duplex UEs, and non-transitory computer-readable medium described herein, the set of multiple messages includes a first uplink message of the one or more uplink messages and the method, apparatuses, and non-transitory computer-readable medium may include further operations, features, means, or instructions for multiplexing the first uplink message onto the second uplink message to generate a multiplexed uplink message based on the first uplink message overlapping at least partially with the second uplink message and determining whether the second SBFD collision may be resolved based on the multiplexed uplink message.

In some examples of the method, half duplex UEs, and non-transitory computer-readable medium described herein, the second SBFD collision may be not resolved based on one or more symbols of the multiplexed uplink message overlapping at least partially with the first downlink message and the one or more symbols may be associated with the first uplink message.

In some examples of the method, half duplex UEs, and non-transitory computer-readable medium described herein, the second SBFD collision may be resolved based on one or more symbols of the multiplexed uplink message being exclusive of the first downlink message and the one or more symbols may be associated with the second uplink message.

A method for wireless communications by a half-duplex UE is described. The method may include receiving a configuration message indicating one or more SBFD symbols for a network entity, where each SBFD symbol of the one or more SBFD symbols includes one or more uplink sub-bands and one or more downlink sub-bands, receiving one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message, and communicate, via the SBFD symbol, at least a subset of the set of multiple messages in accordance with one or more SBFD collision rules.

A half-duplex UE for wireless communications is described. The half-duplex UE may include one or more memories storing processor executable code, and one or more processors coupled with the one or more memories. The one or more processors may individually or collectively be operable to execute the code to cause the half-duplex UE to receive a configuration message indicating one or more SBFD symbols for a network entity, where each SBFD symbol of the one or more SBFD symbols includes one or more uplink sub-bands and one or more downlink sub-bands, receive one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message, and communicate, via the SBFD symbol, at least a subset of the set of multiple messages in accordance with one or more SBFD collision rules.

Another half-duplex UE for wireless communications is described. The half-duplex UE may include means for receiving a configuration message indicating one or more SBFD symbols for a network entity, where each SBFD symbol of the one or more SBFD symbols includes one or more uplink sub-bands and one or more downlink sub-bands, means for receiving one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message, and means for communicate, via the SBFD symbol, at least a subset of the set of multiple messages in accordance with one or more SBFD collision rules.

A non-transitory computer-readable medium storing code for wireless communications is described. The code may include instructions executable by one or more processors to receive a configuration message indicating one or more SBFD symbols for a network entity, where each SBFD symbol of the one or more SBFD symbols includes one or more uplink sub-bands and one or more downlink sub-bands, receive one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message, and communicate, via the SBFD symbol, at least a subset of the set of multiple messages in accordance with one or more SBFD collision rules.

In some examples of the method, half duplex UEs, and non-transitory computer-readable medium described herein, the set of multiple second messages may be multiplexed in the time domain and a first SBFD collision of a set of multiple SBFD collisions may be based on a first portion of the first message overlapping with a second message of the set of multiple second messages and a second SBFD collision of the set of multiple SBFD collisions may be based on a second portion of the first message overlapping with another second message of the set of multiple second messages.

In some examples of the method, half duplex UEs, and non-transitory computer-readable medium described herein, resolving the set of multiple SBFD collisions may include operations, features, means, or instructions for resolving the first SBFD collision based on the second message of the set of multiple second messages being scheduled to be communicated before the other second message.

In some examples of the method, half duplex UEs, and non-transitory computer-readable medium described herein, resolving the first SBFD collision may include operations, features, means, or instructions for refraining from communicating the first message, where the second SBFD collision may be resolved based on refraining from communicating the first message, and where the at least subset of the set of multiple messages includes the set of multiple second messages and excludes the first message.

In some examples of the method, half duplex UEs, and non-transitory computer-readable medium described herein, resolving the first SBFD collision may include operations, features, means, or instructions for refraining from communicating the second message of the set of multiple second messages, where the at least subset of the set of multiple messages excludes the second message of the set of multiple second messages.

In some examples of the method, half duplex UEs, and non-transitory computer-readable medium described herein, resolving the second SBFD collision may include operations, features, means, or instructions for refraining from communicating a second portion of the first message based on the second portion overlapping with the other second message of the set of multiple second messages, where the at least subset of the set of multiple messages excludes the second portion of the first message and includes both a first portion of the first message and the other second message of the set of multiple second messages.

In some examples of the method, half duplex UEs, and non-transitory computer-readable medium described herein, the first transmission direction may be uplink and refraining from communicating the second portion of the first message may be based on an amount of time for uplink cancellation associated with the UE, a capability of the UE to support partial uplink cancellation, or both.

In some examples of the method, half duplex UEs, and non-transitory computer-readable medium described herein, resolving the second SBFD collision may include operations, features, means, or instructions for refraining from communicating the other second message of the set of multiple second messages, where the at least subset of the set of multiple messages excludes the other second message of the set of multiple second messages and includes the first message.

In some examples of the method, half duplex UEs, and non-transitory computer-readable medium described herein, a single SBFD collision may be based on the first message overlapping with the set of multiple second messages.

Some examples of the method, half duplex UEs, and non-transitory computer-readable medium described herein may further include operations, features, means, or instructions for resolving the single SBFD collision may be based on a comparison between a first priority associated with the first message and a second priority associated with the set of multiple second messages.

In some examples of the method, half duplex UEs, and non-transitory computer-readable medium described herein, the second priority may be a highest priority among the set of multiple second messages.

In some examples of the method, half duplex UEs, and non-transitory computer-readable medium described herein, the second priority may be based on a first occurring second message of the set of multiple second messages.

In some examples of the method, half duplex UEs, and non-transitory computer-readable medium described herein, the set of multiple second messages may be multiplexed in the time domain.

In some examples of the method, half duplex UEs, and non-transitory computer-readable medium described herein, the set of multiple second messages may be multiplexed in the frequency domain.

In some examples of the method, half duplex UEs, and non-transitory computer-readable medium described herein, the first transmission direction may be uplink, the second transmission direction may be downlink, the set of multiple second messages includes a synchronization signal block, and resolving the single SBFD collision may be based on one or more SBFD collision rules associated with synchronization signal blocks.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for resolving multiple collisions in sub-band full-duplex (SBFD) symbols in accordance with one or more aspects of the present disclosure.

FIG. 2 shows an example of a wireless communications system that supports techniques for resolving multiple collisions in SBFD symbols in accordance with one or more aspects of the present disclosure.

FIGS. 3A and 3B show examples of SBFD collision scenarios that supports techniques for resolving multiple collisions in SBFD symbols in accordance with one or more aspects of the present disclosure.

FIG. 4 shows an example of an SBFD collision scenario that supports techniques for resolving multiple collisions in SBFD symbols in accordance with one or more aspects of the present disclosure.

FIGS. 5A, 5B, and 5C show examples of SBFD collision scenarios that supports techniques for resolving multiple collisions in SBFD symbols in accordance with one or more aspects of the present disclosure.

FIG. 6 shows an example of a process flow that supports techniques for resolving multiple collisions in SBFD symbols in accordance with one or more aspects of the present disclosure.

FIG. 7 shows an example of a process flow that supports techniques for resolving multiple collisions in SBFD symbols in accordance with one or more aspects of the present disclosure.

FIGS. 8 and 9 show block diagrams of devices that support techniques for resolving multiple collisions in SBFD symbols in accordance with one or more aspects of the present disclosure.

FIG. 10 shows a block diagram of a communications manager that supports techniques for resolving multiple collisions in SBFD symbols in accordance with one or more aspects of the present disclosure.

FIG. 11 shows a diagram of a system including a device that supports techniques for resolving multiple collisions in SBFD symbols in accordance with one or more aspects of the present disclosure.

FIGS. 12 and 13 show flowcharts illustrating methods that support techniques for resolving multiple collisions in SBFD symbols in accordance with one or more aspects of the present disclosure.

### DETAILED DESCRIPTION

In some wireless communications systems, a network entity may operate according to a sub-band full-duplex (SBFD) mode in which the network entity may simultaneously transmit and receive communications. In such cases, the network entity may configure symbols of a half-duplex user equipment (UE), which may be referred to as an SBFD-aware UE, in accordance with an SBFD pattern. That is, the network entity may configure the SBFD-aware UE with one or more SBFD symbols, where each SBFD symbol includes one or more uplink sub-bands (e.g., for uplink transmissions) and one or more downlink sub-bands (e.g., for downlink transmissions). As such, the network entity may transmit one or more downlink messages via the one or more downlink sub-bands of an SBFD symbol and may receive one or more uplink messages via the one or more uplink sub-bands of the SBFD symbol. However, in some cases, the SBFD-aware UE may receive one or more control messages scheduling, via an SBFD symbol, multiple messages including one or more uplink messages, one or more downlink messages, or both, where multiple SBFD collisions occur between the multiple messages. In other words, the UE may be unable to communicate all of the multiple messages based on the multiple SBFD collisions. In some cases, the multiple SBFD collisions may be associated with different SBFD collision types and, in such case, the UE may be unable to determine in what order to resolve the multiple SBFD collisions based on the different SBFD collision types. Additionally, or alternatively, a first message (e.g., of the multiple messages) may overlap with multiple second messages that are multiplexed in a time domain or a frequency domain, such that the UE may be unable to determine whether to treat the overlapping as a single SBFD collision or multiple SBFD collisions.

Accordingly, techniques described herein may enable a UE to resolve multiple SBFD collisions, in an SBFD symbol, associated with different SBFD collision types. For example, the UE may resolve the multiple SBFD collisions in accordance with an SBFD collision type priority order. That is, the SBFD collision type priority order may indicate for the UE to first resolve SBFD collisions associated with a first SBFD collision type, then resolve SBFD collisions associated with a second SBFD collision type, and then resolve SBFD collisions associated with a third SBFD collision type. In some cases, the SBFD collision type priority order may be based on whether the UE received, from a network entity, a transmission direction (e.g., link direction) associated with the SBFD symbol.

Additionally, or alternatively, techniques described herein may enable a UE to resolve multiple SBFD collisions between a single message and multiple second messages (e.g., in a time domain), where the multiple second messages are multiplexed in a time domain or a frequency domain. In some cases, the multiple second messages may be multiplexed in the time domain. In some examples, a first SBFD collision rule may indicate for the UE to treat each overlap between the first message and a second message of the multiple second messages as a separate SBFD collision while, in some other examples, a second SBFD collision rule may indicate for the UE to treat all overlaps between the first message and the multiple second messages as a single SBFD collision. In some other cases, the multiple messages may be multiplexed in the frequency domain. In such cases, a third SBFD collision rule may indicate for the UE to treat all overlaps between the first message and the multiple second messages as a single SBFD collision.

Aspects of the disclosure are initially described in the context of wireless communications systems. Aspects of the disclosure are then described in the context of SBFD collision scenarios and a process flow. Aspects of the disclosure are further illustrated by and described with reference to apparatus diagrams, system diagrams, and flowcharts that relate to techniques for resolving multiple collisions in SBFD symbols.

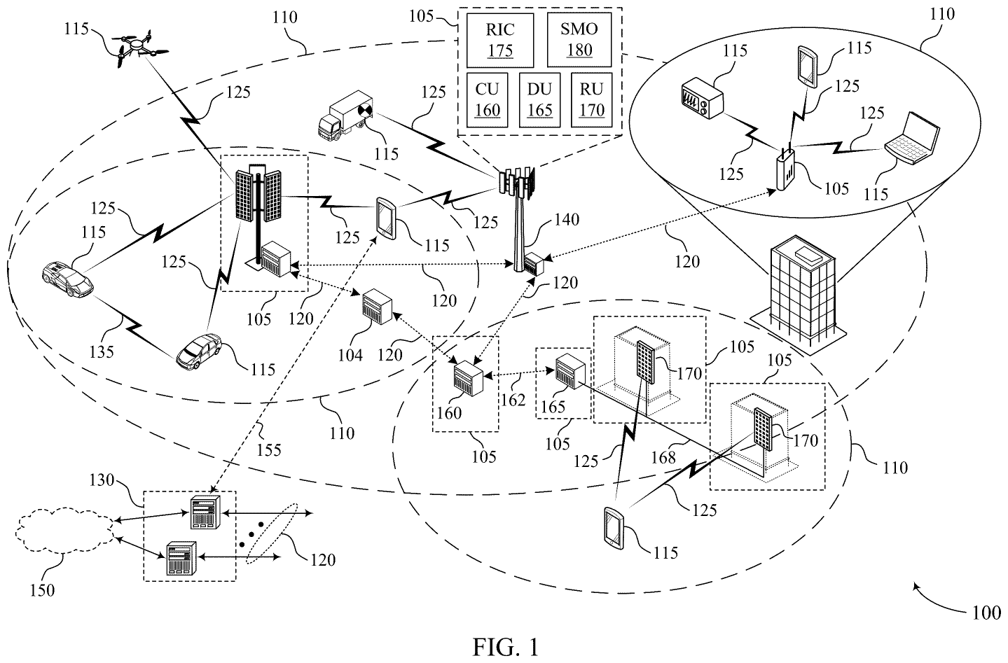

FIG. 1 shows an example of a wireless communications system 100 that supports techniques for resolving multiple collisions in SBFD symbols in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, a UE 115 of the wireless communications system 100 may resolve multiple SBFD collisions, in an SBFD symbol, associated with different SBFD collision types. For example, the UE 115 may resolve the multiple SBFD collisions in accordance with an SBFD collision type priority order. That is, the SBFD collision type priority order may indicate for the UE 115 to first resolve SBFD collisions associated with a first SBFD collision type, then resolve SBFD collisions associated with a second SBFD collision type, and then resolve SBFD collisions associated with a third SBFD collision type. In some cases, the SBFD collision type priority order may be based on whether the UE 115 received, from a network entity, a transmission direction (e.g., link direction) associated with the SBFD symbol.

Additionally, or alternatively, a UE 115 of the wireless communications system 100 may resolve multiple SBFD collisions between a single message and multiple second messages (e.g., in a time domain), where the multiple second messages are multiplexed in a time domain or a frequency domain. In some cases, the multiple second messages may be multiplexed in the time domain. In some examples, a first SBFD collision rule may indicate for the UE 115 to treat each overlap between the first message and a second message of the multiple second messages as a separate SBFD collision while, in some other examples, a second SBFD collision rule may indicate for the UE 115 to treat all overlaps between the first message and the multiple second messages as a single SBFD collision. In some other cases, the multiple messages may be multiplexed in the frequency domain. In such cases, a third SBFD collision rule may indicate for the UE 115 to treat all overlaps between the first message and the multiple second messages as a single SBFD collision.

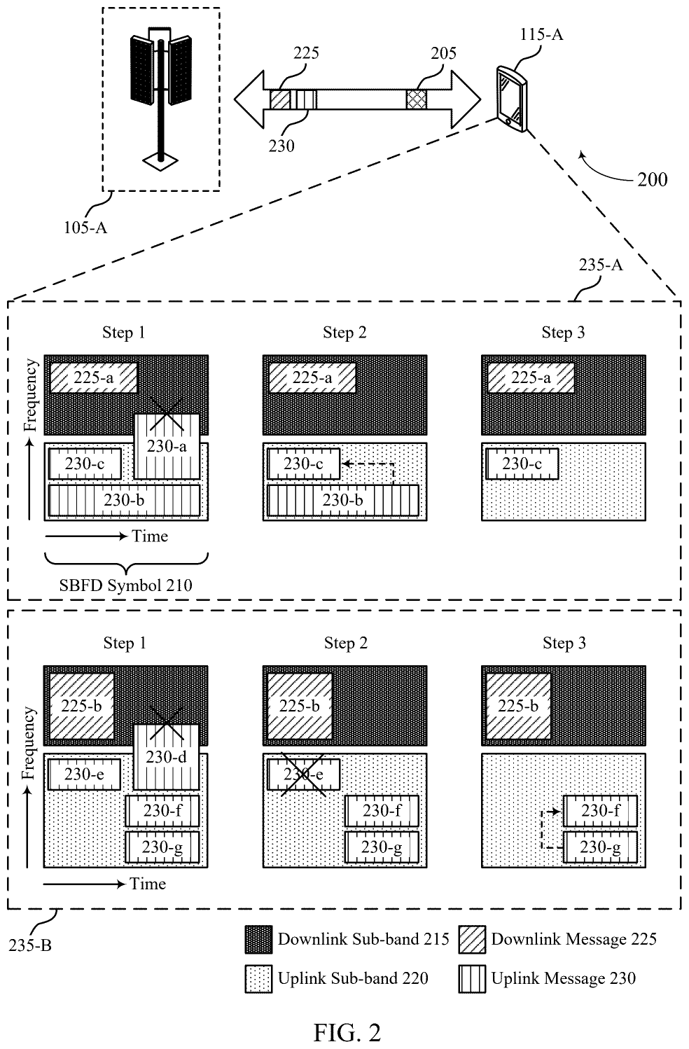

FIG. 2 shows an example of a wireless communications system 200 that supports techniques for resolving multiple collisions in SBFD symbols in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, a network entity 105-a may operate according to an SBFD mode in which the network entity 105-a may simultaneously transmit downlink communications (e.g., one or more downlink messages 225) and receive uplink communications (e.g., one or more uplink messages 230). In such cases, the network entity 105-a may configure symbols (e.g., downlink symbols, flexible symbols) of a UE 115-a in accordance with an SBFD pattern. That is, the network entity 105-a may transmit, to the UE 115-a, a first control message 205 indicating configuration information associated with the SBFD pattern, where the configuration information indicates one or more SBFD symbols 210 and, for each SBFD symbol 210 of the one or more SBFD symbols 210, one or more uplink sub-bands 220 of the SBFD symbol 210 (e.g., for uplink transmissions) and one or more downlink sub-bands 215 of the SBFD symbol 210 (e.g., for downlink transmissions). For example, the first control message 205 may indicate an SBFD symbol 210 with a single downlink sub-band 215 and a single uplink sub-band 220 (e.g., and one or more guard bands).

In some cases, the UE 115-a may be a half-duplex UE 115-a (e.g., SBFD-aware UE 115-a), such that the UE 115-a may not be capable of simultaneously receiving downlink communications and transmitting uplink communications in an SBFD symbol 210. Thus, in some cases, the network entity 105-a may transmit one or more second control message 205 scheduling, via an SBFD symbol 210, multiple messages including one or more downlink messages 225 (e.g., downlink signals, downlink channels), one or more uplink messages 230 (e.g., uplink signals, uplink channels), or both, where the multiple messages result in one or more SBFD collisions associated with one or more SBFD collision types.

For example, a first SBFD collision type (e.g., Case 1), which may be referred to as a frequency domain collision (e.g., SBFD frequency collision), may occur based on a message (e.g., a downlink message 225 or an uplink message 230) overlapping outside of a corresponding sub-band (e.g., overlapping between a downlink sub-band 215 and an uplink sub-band 220). In other words, a message associated with a first transmission direction may overlap (e.g., extend) outside of usable physical resource blocks (PR Bs) associated with the first transmission direction. For example, a frequency collision may occur based on an uplink message 230-a overlapping with the downlink sub-band 215 (e.g., and/or one or more guard bands) or based on a downlink message 225 overlapping with the uplink sub-band 220 (e.g., and/or one or more guard bands, not depicted).

Additionally, a second SBFD collision type (e.g., Case 2), which may be referred to as a multiple uplink collision (e.g., multiple uplink SBFD collision), may occur based on multiple uplink messages 230 at least partially overlapping in a time domain within the uplink sub-band 220 of the SBFD symbol 210 (e.g., within usable PR Bs associated with uplink transmissions). For example, a first multiple uplink collision may occur based on an uplink message 230-b at least partially overlapping (e.g., in the time domain) with an uplink message 230-c and a second multiple uplink collision may occur based on the uplink message 230-b at least partially overlapping with the uplink message 230-a.

Additionally, a third SBFD collision type (e.g., Case 3), which may be referred to as a time domain collision (e.g., SBFD time domain collision), may occur based on an uplink message 230 in the uplink sub-band 220 of the SBFD symbol 210 at least partially overlapping (e.g., in the time domain) with a downlink message 225 in the downlink sub-band 215 of the SBFD symbol 210. For example, a first time domain collision may occur based on a downlink message 225-a at least partially overlapping with the uplink message 230-b and a second time domain collision may occur based on the downlink message 225-a at least partially overlapping with the uplink message 230-c.

Additionally, a fourth SBFD collision type (e.g., Case 4), which may be referred to as a link direction collision (e.g., SBFD link direction collision), may occur based on a message (e.g., a downlink message 225 or an uplink message 230) being associated with a first link direction (e.g., transmission direction) that is different than (e.g., conflicts with) a second link direction associated with (e.g., assigned to) an SBFD symbol 210. For example, the UE 115-a may receive an additional control message 205 indicating the SBFD symbol 210 is configured for (e.g., is to be used for, is associated with) uplink. Thus, a link direction collision may occur based on the downlink message 225-a being scheduled in the SBFD symbol 210 configured for uplink.

In some cases, the network entity 105-a, the UE 115-a, or both, may avoid (e.g., address or alleviate) an SBFD collision (e.g., regardless of SBFD collision type) based on scheduling. However, in some other cases (e.g., if the network entity 105-a does not indicate link direction for an SBFD symbol 210), the network entity 105-a, the UE 115-a, or both, may not be able avoid (e.g., address or alleviate) an SBFD collision based on scheduling. For example, dynamically scheduled downlink communications (e.g., dynamic physical downlink shared channel (PDSCH) or channel state information-reference signal (CSI-RS)) may collide with semi-statically configured uplink communications (e.g., sounding reference signal (SRS), physical uplink control channel (PUCCH), or configured grant-physical uplink shared channel (CG-PUSCH) or physical random access channel (PRA CH)). Additionally, or alternatively, semi-statically configured downlink communications (e.g., PDSCH or semi-persistent scheduling (SPS) PDSCH) may collide with dynamically scheduled uplink communications (e.g., dynamic PUSCH or PUCCH). Additionally, or alternatively, semi-statically configured downlink communications may collide with semi-statically configured uplink communications. Additionally, or alternatively, dynamically scheduled downlink communications may collide with dynamically scheduled uplink communications. Additionally, or alternatively, synchronization signal block (SSB) transmissions may collied with dynamically scheduled or configured uplink communications (e.g., PUSCH, PUCCH, PRACH, SRS). Additionally, or alternatively, dynamically scheduled or semi-statically configured downlink communications may collide with a valid random access occasion (RO).

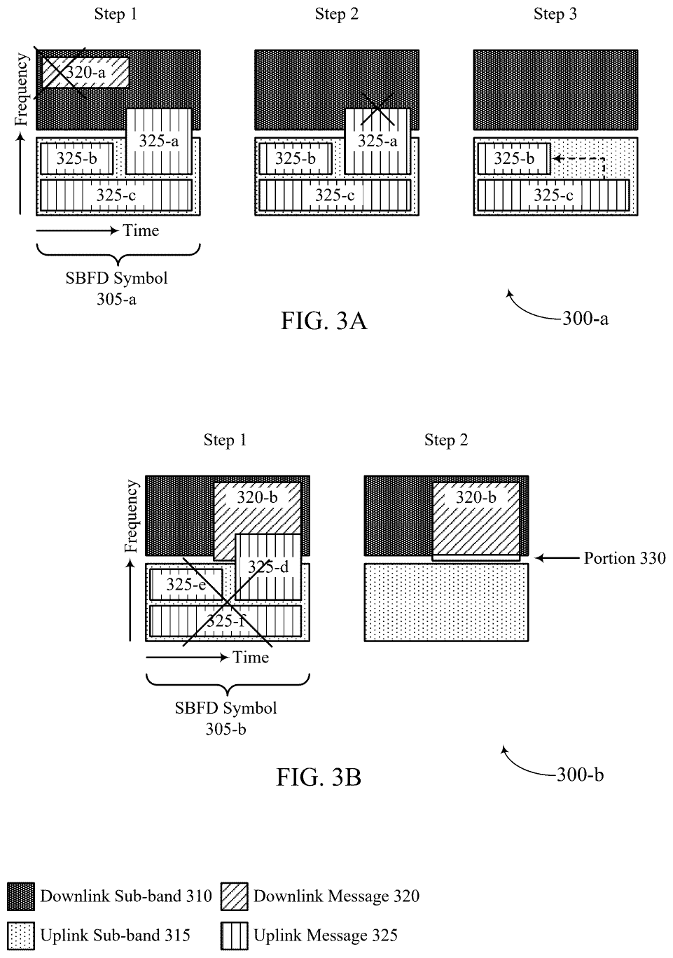

Thus, the UE 115-a may attempt to resolve one or more SBFD collisions in (e.g., associated with) an SBFD symbol 210 according to one or more SBFD collision rules. However, in some cases, as depicted in FIG. 2, the UE 115-a may receive one or more second control messages 205 scheduling, via an SBFD symbol 210, multiple messages including one or more downlink messages 225, one or more uplink messages 230, or both, where the multiple messages result in multiple SBFD collisions associated with multiple SBFD collision types. For example, as depicted in an SBFD collision scenario 235-a, the one or more second control messages 205 may schedule, in the SBFD symbol 210, the downlink message 225-a, the uplink message 230-a, the uplink message 230-b, and the uplink message 230-d. Thus, the SBFD symbol may be associated with at least 5 SBFD collisions (e.g., when link direction is not configured for the SBFD symbol 210). For example, the SBFD symbol 210 may be associated with a frequency collision based on the uplink message 230-a overlapping with the downlink sub-band 215, a first multiple uplink collision based on the uplink message 230-b at least partially overlapping with the uplink message 230-c, a second multiple uplink collision based on the uplink message 230-b at least partially overlapping with the uplink message 230-a, a first time domain collision based on the downlink message 225-a at least partially overlapping with the uplink message 230-b, and a second time domain collision based on the downlink message 225-a at least partially overlapping with the uplink message 230-c. Additionally, if the SBFD symbol 210 is associated with a link direction, the SBFD symbol 210 may be associated with at least one link direction collision, as described further with reference to FIG. 3. In such cases, the UE 115-a may be unable to determine what order to resolve the multiple SBFD collisions associated with the multiple SBFD collision types.

Accordingly, techniques described herein may define one or more SBFD collision type priority orders with which the UE 115-a may use to determine what order to resolve multiple SBFD collisions associated with multiple SBFD collision types. In particular, techniques described herein may define a first SBFD collision type priority order and a second SBFD collision type priority order based on (e.g., associated with) an SBFD symbol 210 not being associated with (e.g., not being configured with) a link direction, as described with reference to FIG. 2, and a third SBFD collision type priority order based on an SBFD symbol 210 being associated with a link direction, as described with reference to FIGS. 3A and 3B.

For example, in some cases (e.g., when link direction is not provided for a set of SBFD symbols 210), the first SBFD collision priority order may indicate for the UE 115-a to resolve frequency collisions first (e.g., at Step 1), resolve multiple uplink collisions second (e.g., at Step 2), and resolve time domain collisions third (e.g., at Step 3). In some examples, an SBFD symbol 210 may not be associated with some SBFD collision types listed in the first SBFD collision priority order. In such cases, the UE 115-a may skip a step if the SBFD symbol 210 is not associated with SBFD collisions of the SBFD collision type associated with the step. For example, if an SBFD symbol 210 is not associated with any multiple uplink collisions, the UE 115-a may skip Step 2.

As an illustrative example, as described in the context of the SBFD collision scenario 235-a, the UE 115-a may receive one or more second control messages 205 scheduling, in an SBFD symbol 210, the downlink message 225-a (e.g., PDSCH), the uplink message 230-a (e.g., SRS), the uplink message 230-b (e.g., PUCCH), and the uplink message 230-d (PUSCH). Thus, the SBFD symbol may be associated with 5 SBFD collisions (e.g., when link direction is not configured for the SBFD symbol 210). For example, the SBFD symbol 210 may be associated with a frequency collision based on the uplink message 230-a overlapping with the downlink sub-band 215, a first multiple uplink collision based on the uplink message 230-b at least partially overlapping with the uplink message 230-c, a second multiple uplink collision based on the uplink message 230-b at least partially overlapping with the uplink message 230-a, a first time domain collision based on the downlink message 225-a at least partially overlapping with the uplink message 230-b, and a second time domain collision based on the downlink message 225-a at least partially overlapping with the uplink message 230-c.

Thus, at Step 1 according to the first SBFD collision type priority order, the UE 115-a may resolve the frequency-domain collision associated with the uplink message 230-a overlapping with the downlink sub-band 215 (e.g., overlapping with one or more first PR Bs outside of the uplink sub-band 220). In such cases, the UE 115-a may resolve the frequency collision by refraining from transmitting (e.g., dropping) or rescheduling (e.g., postponing) the uplink message 230-a (e.g., or at least a portion of the uplink message 230-a that overlaps with the downlink sub-band 220). Additionally, resolving the frequency collision by refraining from transmitting or rescheduling the uplink message 230-a may also resolve the second multiple uplink collision associated with the uplink message 230-b at least partially overlapping with the uplink message 230-a.

In some cases (e.g., not depicted), the UE 115-a may resolve a frequency collision based on a downlink message 225 (e.g., CSI-RS, PDSCH) overlapping with the uplink sub-band 220 (e.g., overlapping with one or more second PRBs outside of the downlink sub-band 215) by refraining from receiving (e.g., refraining from monitoring for, dropping) the downlink message 225, refraining from receiving part of the message downlink message outside the downlink usable PRBs (e.g. the PRBs of the CSI-RS outside the downlink subband or downlink usable PRB) or rate matching the downlink message 225 (e.g., at least a portion of the downlink message 225 that overlaps with the uplink sub-band 220 and/or guard band).

Additionally, at Step 2 according to the first SBFD collision type priority order, the UE 115-a may resolve the first multiple uplink collision associated with the uplink message 230-b at least partially overlapping with the uplink message 230-c (e.g., according one or more SBFD collision rules, an amount of time for multiplexing, an amount of time for dropping, T_{proc,2}, or any combination thereof). In some cases, to resolve a multiple uplink collision, the UE 115-a may multiplex a first uplink message 230 (e.g., PUCCH) associated with a lower priority into a second uplink message 230 (e.g., PUSCH) associated with a higher priority. For example, the uplink message 230-b may be associated with a first priority and the uplink message 230-c may be associated with a second priority greater than the first priority. Thus, to resolve the first multiple uplink collision, the UE 115-a may multiplex the uplink message 230-b into the uplink message 230-c based on the uplink message 230-c being associated with a higher priority than the uplink message 230-b. Additionally, resolving the first multiple uplink collision by multiplexing the uplink message 230-b into the uplink message 230-c may also resolve the first time domain collision associated with the downlink message 225-a at least partially overlapping with the uplink message 230-b.

In some other cases, to resolve a multiple uplink collision, the UE 115-a may refrain from transmitting (e.g., drop, cancel) an uplink message 230 associated with a lower priority. For example, (e.g., not depicted), to resolve the first multiple uplink collision, the UE 115-a may refrain from transmitting the uplink message 230-b based on the uplink message 230-c being associated with a higher priority than the uplink message 230-b.

Additionally, at Step 3 according to the first SBFD collision type priority order, the UE 115-a may resolve the second time domain collision associated with the downlink message 225-a at least partially overlapping with the uplink message 230-c. In such cases, the UE 115-a may resolve the second time domain collision (e.g., determine whether to transmit the uplink message 230-c or receive the downlink message 225-a) according to one or more SBFD time domain collision rules.

In some cases, the UE 115-b may determine a set of symbols associated with the uplink message 325-c based on one or more allocated time domain resources associated with the uplink message 325-c that overlap with the downlink message 225-a (e.g., allocated time domain resources of an uplink signal or channel that overlap with a downlink signal or channel), based on all symbols of the uplink message 230-a, the uplink message 230-b, and the uplink message 325-c (e.g., in Step 2), based on a quantity of symbols, ‘N,’ before a start of the uplink message 325-c (e.g., N=T_{proc2}), or any combination thereof.

In some other cases (e.g., when link direction is not provided for a set of SBFD symbols 210), the second SBFD collision priority order may indicate for the UE 115-a to resolve frequency collisions first (e.g., at Step 1), resolve time domain collisions second (e.g., at Step 2), and resolve multiple uplink collisions third (e.g., at Step 3). In some examples, an SBFD symbol 210 may not be associated with some SBFD collision types listed in the second SBFD collision priority order. In such cases, the UE 115-a may skip a step if the SBFD symbol 210 is not associated with SBFD collisions of the SBFD collision type associated with the step. For example, if an SBFD symbol 210 is not associated with any time domain collisions, the UE 115-a may skip Step 2.

As an illustrative example, as described in the context of an SBFD collision scenario 235-b, the UE 115-a may receive one or more second control messages 205 scheduling, in an SBFD symbol 210, a downlink message 225-b (e.g., PDCCH), an uplink message 230-d (e.g., SRS), an uplink message 230-e (e.g., PUSCH), an uplink message 230-f (e.g., PUCCH), and an uplink message 230-g (e.g., PUCCH). Thus, the SBFD symbol may be associated with 5 SBFD collisions (e.g., when link direction is not configured for the SBFD symbol 210). For example, the SBFD symbol 210 may be associated with a frequency collision based on the uplink message 230-d overlapping with the downlink sub-band 215, a first multiple uplink collision based on the uplink message 230-d at least partially overlapping with the uplink message 230-f, a second multiple uplink collision based on the uplink message 230-d at least partially overlapping with the uplink message 230-g, a third multiple uplink collision based on the uplink message 230-f at least partially overlapping with the uplink message 230-g, and time domain collision based on the downlink message 225-b at least partially overlapping with the uplink message 230-e.

Thus, at Step 1 according to the second SBFD collision type priority order, the UE 115-a may resolve the frequency collision associated with the uplink message 230-d overlapping with the downlink sub-band 215 (e.g., overlapping with one or more first PR Bs outside of the uplink sub-band 220). In such cases, the UE 115-a may resolve the frequency collision by refraining from transmitting (e.g., dropping) or rescheduling (e.g., postponing) the uplink message 230-d (e.g., or at least a portion of the uplink message 230-d that overlaps with the downlink sub-band 215). Additionally, resolving the frequency collision by refraining from transmitting or rescheduling the uplink message 230-a may also resolve the first multiple uplink collision associated with the uplink message 230-d at least partially overlapping with the uplink message 230-f and the second multiple uplink collision associated with the uplink message 230-d at least partially overlapping with the uplink message 230-g.

Additionally, at Step 2 according to the second SBFD collision type priority order, the UE 115-a may resolve the time domain collision associated with the downlink message 225-b at least partially overlapping with the uplink message 230-e. In such cases, the UE 115-a may resolve the time domain collision according to one or more SBFD time domain collision rules. For example, as depicted in FIG. 2, the UE 115-a may refrain from transmitting the uplink message 230-e.

Additionally, at Step 3 according to the second SBFD collision type priority order, the UE 115-a may resolve the third multiple uplink collision associated with the uplink message 230-f at least partially overlapping with the uplink message 230-g. In some cases, the uplink message 230-f may be associated with a first priority and the uplink message 230-g may be associated with a second priority greater than the first priority. Thus, to resolve the third multiple uplink collision, the UE 115-a may multiplex the uplink message 230-g into the uplink message 230-f based on the uplink message 230-f being associated with a higher priority than the uplink message 230-g.

Though depicted in the context of an SBFD symbol 210 with a single downlink sub-band 215 and a single uplink sub-band 220, this is not to be regarded as a limitation of the present disclosure. In this regard, an SBFD symbol 210 may include any quantity of downlink sub-bands 215 and any quantity of uplink sub-bands 220. Additionally, the SBFD symbol 210 may include one or more guard bands.

Additionally, though described in the context of collisions between uplink communications (e.g., one or more uplink messages 230) and downlink communications (e.g., one or more downlink messages 225) in SBFD symbols 210, this is not to be regarded as a limitation of the present disclosure. In this regard, the techniques described herein may also resolve collisions between uplink communications (e.g., transmissions) and downlink communications (e.g., receptions) in different symbols (e.g., SBFD symbols 210, downlink symbols, uplink symbols, flexible symbols, or any combination thereof) or a same symbol, where the uplink communications and the downlink communications are scheduled, at the UE 115-a, within a threshold duration (e.g., minimum transition time) of each other. In other words, the UE 115-a may employ the techniques described herein to resolve collisions between uplink communications and downlink communications (e.g., in different symbols, in a same symbol) when the UE 115-a does not have enough time to transition between the uplink communications and the downlink communications (e.g., or visa-versa).

FIGS. 3A and 3B show examples of SBFD collision scenarios 300 (e.g., an SBFD collision scenario 300-a and an SBFD collision scenario 300-b) that supports techniques for resolving multiple collisions in SBFD symbols in accordance with one or more aspects of the present disclosure. In some cases, the SBFD collision scenarios 300 may implement or be implemented by aspects of the wireless communications system 100, the wireless communications system 200, or both. For example, the SBFD collision scenarios 300 may involve one or more UEs 115 and one or more network entities 105, which may be examples of the corresponding devices as described herein.

In some cases, as described with reference to FIG. 2, a UE 115 may determine what order to resolve multiple SBFD collisions associated with multiple SBFD collision types in accordance with a third SBFD collision type priority order (e.g., based on an SBFD symbol 305 being associated with a link direction). For example, the UE 115 may receive a first control message (e.g., configuration message) indicating configuration information associated with an SBFD pattern, where the configuration information indicates one or more SBFD symbols 305 and, for each SBFD symbol 305 of the one or more SBFD symbols 305, one or more uplink sub-bands 315 of the SBFD symbol 305 (e.g., for uplink transmissions) and one or more downlink sub-bands 310 of the SBFD symbol 305 (e.g., for downlink transmissions). For example, the first control message may indicate an SBFD symbol 305 with a single downlink sub-band 310 and a single uplink sub-band 315 (e.g., and one or more guard bands). Additionally, the UE 115 may receive a second control message indicating a link direction associated with the SBFD symbol 305 (e.g., a link direction for a set of SBFD symbols 305, for each SBFD symbol 305). For example, in the SBFD collision scenario 300-a depicted in FIG. 3A, the second control message may indicate the link direction of an SBFD symbol 305 as uplink and, in the SBFD collision scenario 300-b depicted in FIG. 3B, the second control message may indicate the link direction of an SBFD symbol 305-b.

Additionally, the UE 115-a may receive one or more third control messages (e.g., before or after the second control message) scheduling, via an SBFD symbol 305, multiple messages including one or more downlink messages 320, one or more uplink messages 325, or both, where the multiple messages result in multiple SBFD collisions associated with multiple SBFD collision types.

Thus, the UE 115-a may resolve the multiple SBFD collisions in accordance with the third SBFD collision priority order. In such cases, the third SBFD collision priority order may indicate for the UE 115-a to resolve link direction collisions first (e.g., at Step 1), resolve frequency collisions second (e.g., at Step 2), and, when the link direction for an SBFD symbol 305 is uplink, resolve multiple uplink collisions third (e.g., at Step 3). In some examples, an SBFD symbol 305 may not be associated with some SBFD collision types listed in the third SBFD collision priority order. In such cases, the UE 115-a may skip a step if the SBFD symbol 305 is not associated with SBFD collisions of the SBFD collision type associated with the step. For example, if an SBFD symbol 305 is not associated with any frequency collisions, the UE 115-a may skip Step 2.

As an illustrative example, as described in the context of the SBFD collision scenario 300-a, the UE 115 may receive a second control indicating the link direction of the SBFD symbol 305-a as uplink. Additionally, the UE 115 may receive one or more third control messages scheduling, in the SBFD symbol 305-a, a downlink message 320-a (e.g., PUSCH), an uplink message 325-a (e.g., SRS), an uplink message 325-b (e.g., PUSCH), and an uplink message 325-c (e.g., PUCCH). Thus, the SBFD symbol may be associated with 6 SBFD collisions (e.g., when link direction is indicated as uplink). For example, the SBFD symbol 305-a may be associated with a link direction collision based on the downlink message 320-a and the link direction of the SBFD symbol 305-a being uplink, a first time domain collision based on the downlink message 320-a at least partially overlapping with the uplink message 325-b, a second time domain collision based on the downlink message 320-a at least partially overlapping with the uplink message 325-c, a frequency collision based on the uplink message 325-a overlapping with the downlink sub-band 310, a first multiple uplink collision based on the uplink message 325-b at least partially overlapping with the uplink message 325-c, and a second multiple uplink collision based on the uplink message 325-a at least partially overlapping with the uplink message 325-c.

Thus, at Step 1 according to the third SBFD collision type priority order, the UE 115 may resolve the link direction collision associated with the downlink message 320-a being scheduled in the SBFD symbol 305-a associated with the uplink link direction. In such cases, the UE 115 may resolve the link direction collision by refraining from receiving (e.g., dropping, refraining from monitoring) the downlink message 320-a (e.g., dropping communications with conflicting link directions). Additionally, resolving the frequency collision by refraining from receiving the downlink message 320-a may also resolve both the first time domain collision associated with the downlink message 320-a at least partially overlapping with the uplink message 325-b and the second time domain collision associated with the downlink message 320-a at least partially overlapping with the uplink message 325-c.

Additionally, at Step 2 according to the first SBFD collision type priority order, the UE 115 may resolve the frequency collision associated with the uplink message 325-a overlapping with the downlink sub-band 310 (e.g., overlapping with one or more first PRBs outside of the uplink sub-band 315). In such cases, the UE 115 may resolve the frequency collision by refraining from transmitting (e.g., dropping) or rescheduling (e.g., postponing) the uplink message 325-a. In some examples, the UE 115 may resolve the frequency collision by refraining from transmitting a portion of the uplink message 325-a that occurs outside of the uplink sub-band 315 (e.g., overlaps with the downlink sub-band 310). Additionally, resolving the frequency collision by refraining from transmitting or rescheduling the uplink message 325-a may also resolve the second multiple uplink collision associated with the uplink message 325-a at least partially overlapping with the uplink message 325-c.

Additionally, at Step 3 according to the first SBFD collision type priority order, the UE 115 may resolve the first multiple uplink collision associated with the uplink message 325-b at least partially overlapping with the uplink message 325-c (e.g., according one or more SBFD collision rules, an amount of time for multiplexing, an amount of time for dropping, or any combination thereof). In some cases, to resolve a multiple uplink collision, the UE 115 may multiplex a first uplink message 325 (e.g., PUCCH) associated with a lower priority into a second uplink message 325 (e.g., PUSCH) associated with a higher priority. For example, the uplink message 325-c may be associated with a first priority and the uplink message 325-b may be associated with a second priority greater than the first priority. Thus, to resolve the first multiple uplink collision, the UE 115 may multiplex the uplink message 325-c into the uplink message 325-b based on the uplink message 325-b being associated with a higher priority than the uplink message 325-c.

In some other cases, to resolve a multiple uplink collision, the UE 115-a may refrain from transmitting (e.g., drop, cancel) an uplink message 325 associated with a lower priority. For example, (e.g., not depicted), to resolve the first multiple uplink collision, the UE 115-a may refrain from transmitting the uplink message 325-c based on the uplink message 325-b being associated with a higher priority than the uplink message 325-c.

In another illustrative example, as described in the context of the SBFD collision scenario 300-b, the UE 115 may receive a second control indicating the link direction of the SBFD symbol 305-b as downlink. Additionally, the UE 115 may receive one or more third control messages scheduling, in the SBFD symbol 305-b, a downlink message 320-b (e.g., PDSCH), an uplink message 325-d (e.g., SRS), an uplink message 325-e (e.g., PUSCH), and an uplink message 325-f (e.g., PUCCH). Thus, the SBFD symbol may be associated with 9 SBFD collisions (e.g., when link direction is indicated as downlink). For example, the SBFD symbol 305-b may be associated with a first link direction collision based on the uplink message 325-d and the link direction of the SBFD symbol 305-b being downlink, a second link direction collision based on the uplink message 325-e and the link direction of the SBFD symbol 305-b being downlink, a third link direction collision based on the uplink message 325-f and the link direction of the SBFD symbol 305-b being downlink, a first time domain collision based on the downlink message 320-b at least partially overlapping with the uplink message 325-d, a second time domain collision based on the downlink message 320-b at least partially overlapping with the uplink message 325-f, a first frequency collision based on the uplink message 325-d overlapping with the downlink sub-band 310, a second frequency domain collision based on the downlink message 320-b overlapping with the uplink sub-band 315, a first multiple uplink collision based on the uplink message 325-d at least partially overlapping with the uplink message 325-f, and a second multiple uplink collision based on the uplink message 325-e at least partially overlapping with the uplink message 325-f.

Thus, at Step 1 according to the third SBFD collision type priority order, the UE 115 may resolve the first link direction collision associated with the uplink message 325-d and the link direction of the SBFD symbol 305-b being downlink, the second link direction collision associated with the uplink message 325-e and the link direction of the SBFD symbol 305-b being downlink, and the third link direction collision associated with the uplink message 325-d and the link direction of the SBFD symbol 305-b being downlink. In such cases, the UE 115 may resolve the first link direction collision, the second link direction collision, and the third link direction collision by refraining from transmitting the uplink message 325-d, the uplink message 325-e, and the uplink message 325-f, respectively. Additionally, resolving the first link direction collision, the second link direction collision, and the third link direction collision by refraining from transmitting the uplink message 325-d, the uplink message 325-e, and the uplink message 325-f, respectively, may also resolve the first time domain collision, the second time domain collision, the first frequency collision, the first multiple uplink collision, and the second multiple uplink collision.

Additionally, at Step 2 according to third first SBFD collision type priority order, the UE 115 may resolve the second frequency collision associated with the downlink message 320-b overlapping with the uplink sub-band 315 (e.g., overlapping with one or more first PR Bs outside of the downlink sub-band 310). In such cases, the UE 115 may resolve the second frequency collision by refraining from receiving (e.g., refraining from monitoring for, dropping) the downlink message 320-b (e.g., CSI-RS, PDSCH), or rate matching the downlink message 320-b (e.g., PDSCH). In some examples, the UE 115 may resolve the second frequency collision by refraining from receiving a portion 330 of the downlink message 320-b that occurs outside of the downlink sub-band 310.

Though depicted in the context of SBFD symbols 305 each with a single downlink sub-band 310 and a single uplink sub-band 315, this is not to be regarded as a limitation of the present disclosure. In this regard, an SBFD symbol 305 may include any quantity of downlink sub-bands 310 and any quantity of uplink sub-bands 315. Additionally, the SBFD symbol 305 may include one or more guard bands.

Additionally, though described in the context of collisions between uplink communications (e.g., one or more uplink messages 325) and downlink communications (e.g., one or more downlink messages 320) in SBFD symbols 305, this is not to be regarded as a limitation of the present disclosure. In this regard, the techniques described herein may also resolve collisions between uplink communications (e.g., transmissions) and downlink communications (e.g., receptions) in different symbols (e.g., SBFD symbols 305, downlink symbols, uplink symbols, flexible symbols, or any combination thereof) or a same symbol, where the uplink communications and the downlink communications are scheduled, at the UE 115, within a threshold duration (e.g., minimum transition time) of each other. In other words, the UE 115 may employ the techniques described herein to resolve collisions between uplink communications and downlink communications (e.g., in different symbols, in a same symbol) when the UE 115 does not have enough time to transition between the uplink communications and the downlink communications (e.g., or visa-versa).

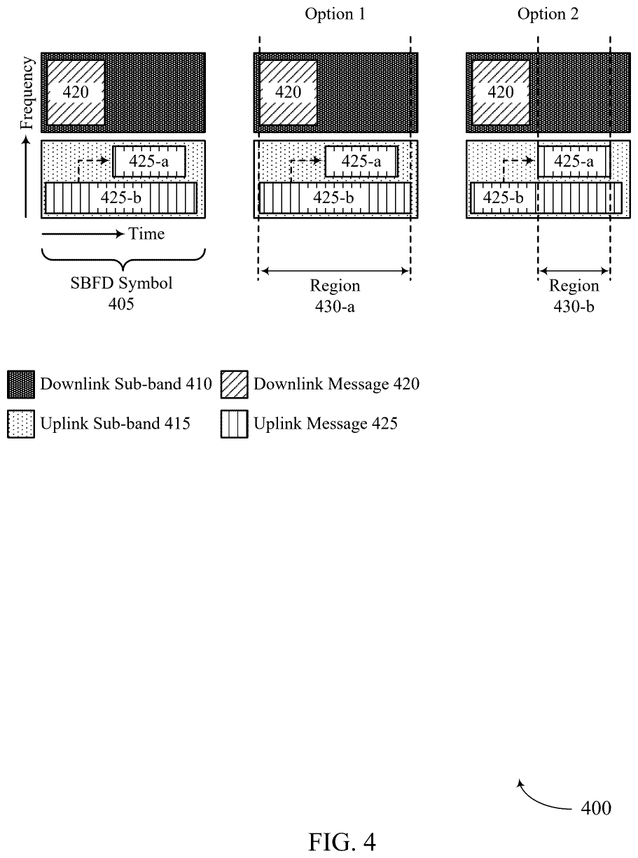

FIG. 4 shows an example of an SBFD collision scenario 400 that supports techniques for resolving multiple collisions in SBFD symbols in accordance with one or more aspects of the present disclosure. In some cases, the SBFD collision scenario 400 may implement or be implemented by aspects of the wireless communications system 100, the wireless communications system 200, the SBFD collision scenarios 300, or any combination thereof. For example, the SBFD collision scenario 400 may involve one or more UEs 115 and one or more network entities 105, which may be examples of the corresponding devices as described herein.

In some cases, as described with reference to FIGS. 2, 3A, and 3B, a UE 115 may resolve a multiple uplink collision based on multiplexing a lower priority uplink message 425 into a higher priority uplink message. For example, the UE 115 may receive one or more control messages scheduling, via an SBFD symbol 405, a downlink message 420 (e.g., PDCCH) via a downlink sub-band 410, and both an uplink message 425-a (e.g., PUSCH) and an uplink message 425-b (e.g., PUCCH) via an uplink sub-band 415. Thus, the SBFD symbol 405 may be associated with a time domain collision based on the downlink message 420 at least partially overlapping with the uplink message 425-b and a multiple uplink collision based on the uplink message 425-a at least partially overlapping with the uplink message 425-b.

In some cases (e.g., according to the first SBFD collision priority order when link direction is not known by the UE 115), the UE 115 may resolve the multiple uplink collision first by multiplexing the uplink message 425-b into the uplink message 425-a to generate a multiplexed uplink message 425 based on the uplink message 425-b being associated with a lower priority than the uplink message 425-a. Thus, the multiplexed uplink message may include a first set of symbols associated with the uplink message 425-a (e.g., in a region 430-b) and a second set of symbols associated with the uplink message 425-b (e.g., in a region 430-a), where the first set of symbols do not overlap (e.g., are separate from, are independent of) with the downlink message 420 but the second set of symbols at least partially overlap (e.g., in a time domain) with the downlink message 420.

In some examples, a first SBFD collision rule may indicate for the UE 115 to determine whether the time domain collision still exists (e.g., after resolving the multiple uplink collision) based on a combination (e.g., union) of the first set of symbols and the second set of symbols. In other words, the UE 115 may determine the time domain collision still exists based on the downlink message 420 at least partially overlapping with the second set of symbols (e.g., of the multiplexed uplink message 425) associated with the uplink message 425-b (e.g., in the region 430-a).

In some other examples, a second SBFD collision rule may indicate for the UE 115 to determine whether the time domain collision still exists (e.g., after resolving the multiple uplink collision) based on a set of symbols associated with a higher priority uplink message 425 (e.g., selected uplink message 425). In other words, the UE 115 may determine that resolving the multiple uplink collision resolved the time domain collision based on the downlink message 420 not overlapping with the first set of symbols (e.g., of the multiplexed uplink message 425) associated with the uplink message 425-a (e.g., in the region 430-b).

Though depicted in the context of SBFD symbols 405 each with a single downlink sub-band 410 and a single uplink sub-band 415, this is not to be regarded as a limitation of the present disclosure. In this regard, an SBFD symbol 405 may include any quantity of downlink sub-bands 410 and any quantity of uplink sub-bands 415. Additionally, the SBFD symbol 405 may include one or more guard bands.

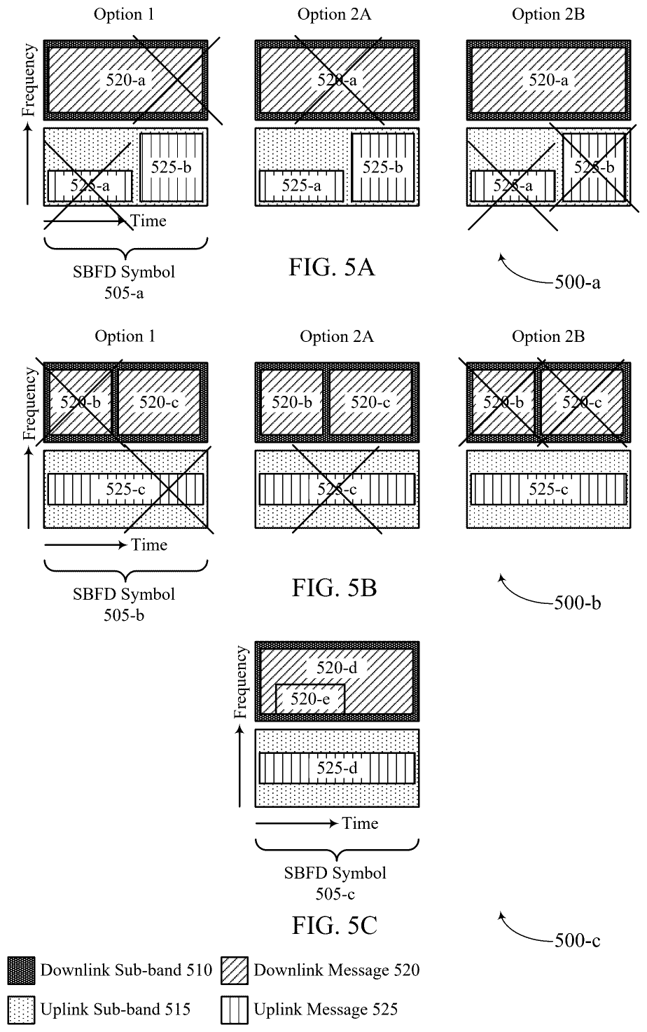

FIGS. 5A, 5B, and 5C show examples of SBFD collision scenarios 500 (e.g., an SBFD collision scenario 500-a, an SBFD collision scenario 500-b, and an SBFD collision scenario 500-c) that supports techniques for resolving multiple collisions in SBFD symbols in accordance with one or more aspects of the present disclosure. In some cases, the SBFD collision scenarios 500 may implement or be implemented by aspects of the wireless communications system 100, the wireless communications system 200, the SBFD collision scenarios 300, the SBFD collision scenario 400, or any combination thereof. For example, the SBFD collision scenarios 500 may involve one or more UEs 115 and one or more network entities 105, which may be examples of the corresponding devices as described herein.

In some cases, as described with reference to FIG. 2, a network entity 105 may configure symbols (e.g., downlink symbols, flexible symbols) of a UE 115 in accordance with an SBFD pattern. That is, the network entity 105 may transmit, to the UE 115, a first control message indicating configuration information associated with the SBFD pattern, where the configuration information indicates one or more SBFD symbols 505 (e.g., an SBFD symbol 505-a, an SBFD symbol 505-b, and an SBFD symbol 505-c) and, for each SBFD symbol 505 of the one or more SBFD symbols 505, one or more uplink sub-bands 515 of the SBFD symbol 505 (e.g., for uplink transmissions) and one or more downlink sub-bands 510 of the SBFD symbol 505 (e.g., for downlink transmissions). For example, the first control message may indicate SBFD symbols 505 with a single downlink sub-band 510 and a single uplink sub-band 515 (e.g., and one or more guard bands).

In some cases, as described previously, the UE 115 may be a half-duplex UE 115 (e.g., SBFD-aware UE 115), such that the UE 115-a may not be capable of simultaneously receiving downlink communications and transmitting uplink communications in an SBFD symbol 505. Thus, in some cases, the network entity 105 may transmit one or more second control message scheduling, via an SBFD symbol 505, multiple messages including one or more downlink messages 520 (e.g., downlink signals, downlink channels), one or more uplink messages 525 (e.g., uplink signals, uplink channels), or both, where a first message (e.g., of the multiple messages) may overlap with multiple second messages that are multiplexed in a time domain or a frequency domain, such that the UE 115 may be unable to determine whether to treat (e.g., consider) the overlapping as a single time domain collision, where each second message is associated with a separate time domain collision (e.g., with the first message) or multiple time domain collisions, where all of the second messages are associated with a same time domain collision (e.g., with the first message)

Accordingly, techniques described herein may enable the UE 115 to resolve multiple time domain collisions between a single first message and multiple second messages, where the multiple second messages are multiplexed in a time domain or a frequency domain (e.g., when link direction is not provided, is not known by the UE 115). For example, as described in the context of the SBFD collision scenario 500-a, the UE 115 may receive one or more control messages scheduling, via the SBFD symbol 505-a, a downlink message 520-a (e.g., PDSCH) in the downlink sub-band 510 and both an uplink message 525-a (e.g., PUSCH) and an uplink message 525-b (e.g., SRS) in the uplink sub-band 515, where the uplink message 525-a and the uplink message 525-b are multiplexed in the time domain (e.g., TDM ed).

In some cases, a third SBFD collision rule may indicate for the UE 115 to identify a unique (e.g., different) time domain collision per uplink message 525 (e.g., per TDM ed uplink messages 525) and resolve each unique time domain collision independently. For example, the UE 115 may identify a first time domain collision based on a first portion of the downlink message 520-a overlapping at least partially with the uplink message 525-a and a second time domain collision based on a second portion of the downlink message 520-b at least partially overlapping with the uplink message 525-b. Thus, the UE 115 may resolve both of the first time domain collision and the second time domain collision.

In some cases, the UE 115 may resolve the first time domain collision and the second time domain collision according to an order of collisions based on time. That is, the UE 115 may resolve SBFD collisions in accordance with an order that the uplink message 525 occur in the SBFD symbol 505-a. For example, the UE 115 may resolve the first time domain collision associated with the uplink message 525-a first and may resolve the second time domain collision associated with the uplink message 525-b second based on the uplink message 525-a occurring first (e.g., earlier) than the uplink message 525-b in the SBFD symbol 505-a.

In examples (e.g., not depicted), to resolve the first time domain collision, the UE 115 may refrain from receiving (e.g., drop) the downlink message 520-a based on prioritizing the uplink message 525-a over the downlink message 520-a (e.g., based one or more SBFD collision rules). The UE 115 may refrain from receiving the entire downlink message 520-a (e.g., a full drop when the downlink message 520-a is PDSCH) or refrain from receiving the downlink message 520-a only at the overlapping symbols with the uplink message 525-a (e.g., a partial drop when the uplink message 525-a is a CSI-RS or a DL-PRS). In such cases, the second time domain collision may be resolved (e.g., skipped) based on resolving the first time domain collision (e.g., based on dropping the downlink message 520-a). In some other examples, as depicted in Option 1 of FIG. 5A, to resolve the first time domain collision, the UE 115 may refrain from transmitting (e.g., drop) the uplink message 525-a based on prioritizing the downlink message 520-a over the uplink message 525-a (e.g., SPS-PDSCH>CG-PUSCH). Thus, the UE 115 may resolve the second time domain collision (e.g., separately, second).

In some cases (e.g., not depicted), to resolve the second time domain collision, the UE 115 may prioritize the downlink message 520-a over the uplink message 525-b, such that the UE 115 receives the downlink message 520-a in the SBFD symbol 505-a and refrains from transmitting both the uplink message 525-a and the uplink message 525-b in the SBFD symbol 505-a. In some other cases, as depicted in Option 1 of FIG. 5A, to resolve the second time domain collision, the UE 115 may prioritize the uplink message 525-b over the downlink message 520-a (e.g., AP-SRS>PDSCH), such that the UE 115 receives the first portion of the downlink message 520-a (e.g., not overlapping with the uplink message 525-b) in the SBFD symbol 505-a, refrains from receiving the second portion of the downlink message 520-a (e.g., overlapping with the uplink message 525-b) in the SBFD symbol 505-a, refrains from transmitting the uplink message 525-a in the SBFD symbol 505-a, and transmits the uplink message 525-b in the SBFD symbol 505-a.

In some other cases, a fourth SBFD collision rule may indicate for the UE 115 to identify a single time domain collision associated with all uplink messages 525 (e.g., all TDM ed uplink message 525 in the SBFD symbol 505-a) and resolve the single time domain collision. In some examples, a collective priority of the uplink message 525-a and the uplink message 525-b may be based on a higher priority uplink message 525 of the uplink message 525-a and the uplink message 525-b. For example, the uplink message 525-a (e.g., PUSCH) may be associated with a first priority and the uplink message 525-b (e.g., SRS) may be associated with a second priority greater than the first priority. Thus, the collective priority may be the second priority. In some examples, as depicted in Option 2A of FIG. 5A, to resolve the single time domain collision, the UE 115 may prioritize the uplink messages 525 over the downlink message 520-a based on the second priority (e.g., collective priority) being greater than a third priority associated with the downlink message 520-a (e.g., SRS>SPS-PDSCH). In some other examples, the collective priority may be based on a first (e.g., earlier) uplink message 525 in the SBFD symbol 505-a. For example, the collective priority may be the first priority based on the uplink message 525-a occurring before (e.g., being scheduled before) the uplink message 525-b in the SBFD symbol 505-a. In some examples, as depicted in Option 2B of FIG. 5A, to resolve the single time domain collision, the UE 115 may prioritize the downlink message 520-a over the uplink messages 525 based on the first priority (e.g., collective priority) being less than the third priority associated with the downlink message 520-a (e.g., SPS-PDSCH>PUSCH).

In some cases, a fifth SBFD collision rule may indicate for the UE 115 to identify a unique (e.g., different) time domain collision per downlink message 520 (e.g., per TDM ed downlink message 520) and resolve each unique time domain collision independently. For example, according to the SBFD collision scenario 500-b, the UE 115 may identify a third time domain collision based on a first portion of an uplink message 525-c (e.g., PUSCH) overlapping at least partially with a downlink message 520-b (e.g., PDCCH) in an SBFD symbol 505-b and a fourth time domain collision based on a second portion of the uplink message 525-c overlapping at least partially with a downlink message 520-c (e.g., PDSCH) in the SBFD symbol 505-b. Thus, the UE 115 may resolve both of the third time domain collision and the fourth time domain collision.

In some cases, the UE 115 may resolve the first time domain collision and the second time domain collision according to an order of collisions based on time. That is, the UE 115 may resolve SBFD collisions in accordance with an order that the downlink messages 520 occur in the SBFD symbol 505-b. For example, the UE 115 may resolve the third time domain collision associated with the downlink message 520-b first and may resolve the fourth time domain collision associated with the downlink message 520-c second based on the downlink message 520-b occurring first (e.g., earlier) than the downlink message 520-c in the SBFD symbol 505-b.

In examples (e.g., not depicted), to resolve the third time domain collision, the UE 115 may refrain from transmitting the uplink message 525-c based on prioritizing the downlink message 520-b over the uplink message 525-c (e.g., based one or more SBFD collision rules). The UE 115 may refrain from transmitting the entire uplink message 525-c (e.g., fully cancel when the uplink message 525-c is a PUSCH) or refrain from transmitting the uplink message 525-c only at overlapping symbols with the downlink message 520-b (e.g., a partial drop when the uplink message 525-c is an SRS). In such cases, the fourth time domain collision may be resolved (e.g., skipped) based on resolving the third time domain collision (e.g., based on dropping the uplink message 525-c). In some other examples, as depicted in Option 1 of FIG. 5B, to resolve the third time domain collision, the UE 115 may refrain from receiving the downlink message 520-b based on prioritizing uplink message 525-c over the downlink message 520-b (e.g., CG-PUSCH>PDCCH). Thus, the UE 115 may resolve the fourth time domain collision (e.g., separately, second). In some cases (e.g., not depicted), to resolve the second time domain collision, the UE 115 may prioritize the downlink message 520-c over the uplink message 525-c, such that the UE 115 receives both the downlink message 520-b and the downlink message 520-c in the SBFD symbol 505-b and refrains from transmitting the uplink message 525-c in the SBFD symbol 505-b. In some other cases, as depicted in Option 1 of FIG. 5B, to resolve the fourth time domain collision, the UE 115 may prioritize the downlink message 520-c over the uplink message 525-c (e.g., dynamic grant PDSCH (DG-PDSCH)>CG-PUSCH), such that the UE 115 transmits the first portion of the uplink message 525-c (e.g., not overlapping with the downlink message 520-c) in the SBFD symbol 505-b, refrains from transmitting the second portion of the uplink message 525-c (e.g., overlapping with the downlink message 520-c) in the SBFD symbol 505-b, refrains from receiving the downlink message 520-b in the SBFD symbol 505-b, and receives the downlink message 520-c in the SBFD symbol 505-b. In some cases, the UE 115 may perform partial cancellation of the uplink message 525-c based on a capability of the UE 115 to support partial cancellation, based on satisfying a threshold amount of time for cancellation (e.g., threshold cancellation timeline), or both. Otherwise, if the UE 115 prioritizes the uplink message 525-c over at least one downlink message 520, the UE 115 may prioritize the uplink message 525-c over all downlink messages 520 (e.g., based on the UE 115 not supporting partial cancellation, based on failing to satisfy the threshold amount of time for cancellation, or both)

In some other cases, a sixth SBFD collision rule may indicate for the UE 115 to identify a single time domain collision associated with all downlink messages 520 (e.g., all TDM ed downlink messages 520 in the SBFD symbol 505-b) and resolve the single time domain collision. In some examples, a collective priority of the downlink message 520-b and the downlink message 520-c may be based on a higher priority downlink message 520 of the downlink message 520-b and the downlink message 520-c. For example, the downlink message 520-b (e.g., PDCCH) may be associated with a first priority and the downlink message 520-c (e.g., PDSCH) may be associated with a second priority greater than the first priority. Thus, the collective priority may be the second priority. In some examples, as depicted in Option 2A of FIG. 5B, to resolve the single time domain collision, the UE 115 may prioritize the downlink messages 520 over the uplink message 525-c based on the second priority (e.g., collective priority) being greater than a third priority associated with the uplink message 525-c (e.g., DG-PDSCH>CG-PUSCH). In some other examples, the collective priority may be based on a first (e.g., earlier) downlink message 520 in the SBFD symbol 505-b. For example, the collective priority may be the first priority based on the downlink message 520-b occurring before (e.g., being scheduled before) the downlink message 520-c in the SBFD symbol 505-b. In some examples, as depicted in Option 2B of FIG. 5B, to resolve the single time domain collision, the UE 115 may prioritize the uplink message 525-c over the downlink messages 520 based on the first priority (e.g., collective priority) being less than the third priority associated with the downlink message 520-a (e.g., CG-PUSCH>PDCCH).

In some cases, as described in the context of the SBFD collision scenario 500-c, the network entity 105 may transmit one or more second control message scheduling, via an SBFD symbol 505, such as an SBFD symbol 505-c, multiple messages including multiple downlink messages 520, such as a downlink message 520-d and a downlink message 520-e, and a single uplink message 525, such as an uplink message 525-d (e.g., PUSCH), where the downlink message 520-d and the downlink message 520-e are multiplexed in the frequency domain (e.g., are FDM ed) and both at least partially overlap with the uplink message 525-d.

In such cases, a seventh SBFD collision rule may indicate for the UE 115 to identify a single time domain collision associated with the downlink messages 520 (e.g., all FDM ed downlink messages 520) and resolve the single time domain collision. In some examples, a collective priority of the downlink message 520-d and the downlink message 520-e may be based on a higher priority downlink message 520 of the downlink message 520-d and the downlink message 520-e. For example, the downlink message 520-d (e.g., periodic/semi-persistent CSI-RS, RRC) may be associated with a first priority and the downlink message 520-e (e.g., DG-PDSCH) may be associated with a second priority greater than the first priority. Thus, the collective priority may be the second priority (e.g., DG-PDSCH priority).

In some other examples, when a downlink message 520, such as the downlink message 520-d, is an SSB, the UE 115 may apply one or more SBFD collision rules (e.g., priority rules) associated with SSBs. In either case, if the uplink message 525-c is dropped (e.g., canceled), the UE 115 may determine a time, ‘T_{proc2},’ with respect to a last symbol of a control resource set (CORESET) where the UE 115 detects a DCI format (e.g., scheduling PDSCH or PUSCH).

Though depicted in the context of SBFD symbols 505 each with a single downlink sub-band 510 and a single uplink sub-band 515, this is not to be regarded as a limitation of the present disclosure. In this regard, an SBFD symbol 505 may include any quantity of downlink sub-bands 510 and any quantity of uplink sub-bands 515. Additionally, the SBFD symbol 505 may include one or more guard bands.

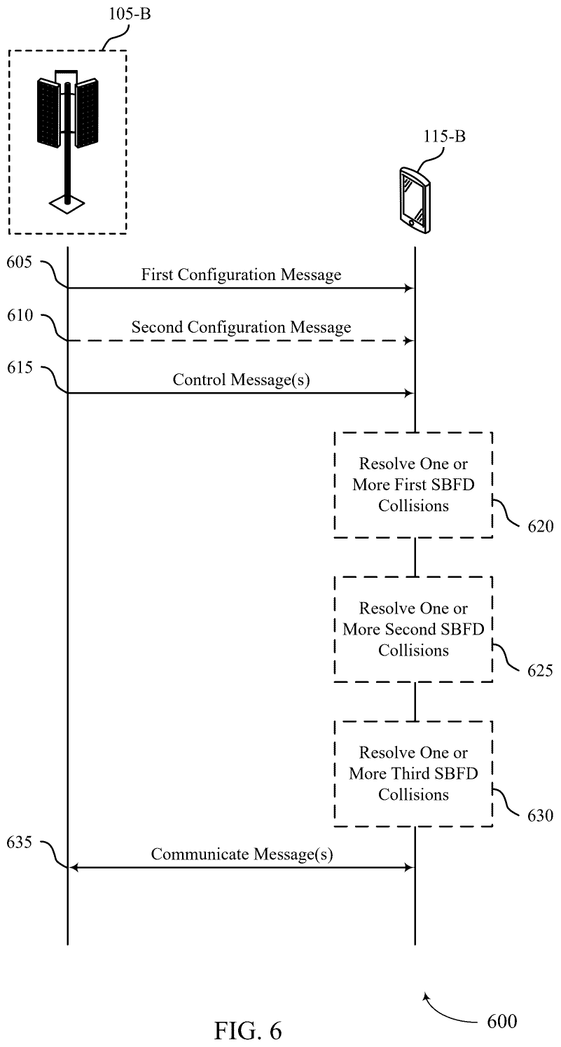

FIG. 6 shows an example of a process flow 600 that supports techniques for resolving multiple collisions in SBFD symbols in accordance with one or more aspects of the present disclosure. In some cases, the process flow 600 may implement or be implemented by aspects of the wireless communications system 100, the wireless communications system 200, the SBFD collision scenarios 300, the SBFD collision scenario 400, the SBFD collision scenarios 500, or any combination thereof. For example, the process flow 600 may include one or more UEs 115 (e.g., a UE 115-b) and one or more network entities 105 (e.g., a network entity 105-b), which may be examples of the corresponding devices as described herein. In the following description of the process flow 600, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 600, and other operations may be added to the process flow 600.

At 605, the UE 115-b (e.g., a half-duplex UE 115-b, an SBFD-aware UE 115-b) may receive, from the network entity 105-b, a first configuration message (e.g., control message) indicating one or more SBFD symbols for the network entity 105-b (e.g., operating according to an SBFD mode, an SBFD network entity 105-b), where each SBFD symbol of the one or more SBFD symbols includes one or more uplink sub-bands and one or more downlink sub-bands (e.g., and one or more guard bands).

In some cases, at 610, the UE 115-b may receive a second configuration message (e.g., control message) indicating a respective link direction (e.g., transmission direction, uplink, downlink) associated with each SBFD symbol of the one or more SBFD symbols. For example, the first control message may indicate a first link direction associated with an SBFD symbol of the one or mor SBFD symbols.

At 615, the UE 115-b may receive one or more control messages scheduling multiple messages during the SBFD symbol of the one or more SBFD symbols, where the multiple messages include one or more uplink messages (e.g., uplink transmissions), one or more downlink messages (e.g., downlink transmissions), or both. In such cases, the multiple messages may be associated with multiple SBFD collisions within the SBFD symbol, where the multiple SBFD collisions are associated with multiple SBFD collision types. The multiple SBFD collision types may include any combination of a first SBFD collision type (e.g., frequency collisions) associated with at least a first subset of the multiple messages overlapping at least partially outside of the one or more downlink sub-bands or the one or more uplink sub-bands (e.g., extending out of corresponding usable PRBs), a second SBFD collision type (e.g., multiple uplink collisions) associated with at least a second subset of the multiple messages associated with a same transmission direction (e.g., at least a subset of the one or more uplink messages) overlapping in a time domain, a third SBFD collision type (e.g., time domain collisions) associated with at least a third subset of the multiple messages associated with different transmission directions overlapping in the time domain, and a fourth SBFD collision type (e.g., link direction collisions) associated with at least a fourth subset of the multiple messages being associated with a second link direction different than the first link direction associated with the SBFD symbol (e.g., as indicated via the second configuration message).

In some cases, at 620, the UE 115-b may resolve, at a first time, one or more first SBFD collisions from the plurality of SBFD collisions. In some examples, according to a first SBFD collision type priority order or a second SBFD collision type priority order (e.g., when the first link direction is not known, when the second configuration message is not received by the UE 115-b and/or is not transmitted by the network entity 105-b), the UE 115-b may resolve the one or more first SBFD collisions based on the one or more first SBFD collisions being associated with the first SBFD collision type. In some cases, the one or more first SBFD collisions may be based on a first uplink message of the one or more uplink messages at least partially overlapping with one or more resources outside of the one or more uplink sub-bands (e.g., in the one or more downlink sub-bands, in one or more guard bands, or both), such that, to resolve the one or more first SBFD collisions, the UE 115-b may refrain from transmitting at least a portion of the first uplink message via the SBFD symbol based on the at least portion of the first uplink message overlapping with the one or more resources outside of the one or more uplink sub-bands. In some other cases, the one or more first SBFD collisions may be based on a first downlink message of the one or more downlink messages at least partially overlapping with one or more resources outside of the one or more downlink sub-bands (e.g., in the one or more uplink sub-bands, in one or more guard bands, or both), such that, to resolve the one or more first SBFD collisions, the UE 115-b may refrain from receiving at least a portion of the first downlink message via the SBFD symbol based on the at least portion of the first downlink message overlapping with the one or more resources outside of the one or more downlink sub-bands.

In some other cases, according to a third SBFD collision type priority order (e.g., when the first link direction is known, when the UE 115-b receives the second configuration message), the UE 115-b may resolve the one or more first SBFD collisions based on the one or more first SBFD collisions being associated with the fourth SBFD collision type. In such cases, the resolve the one or more first SBFD collisions, the UE 115-b may either refrain from receiving (e.g., drop) the one or more downlink messages based on the first link direction being uplink or refrain from transmitting (e.g., drop, cancel) the one or more uplink messages based on the first link direction being downlink.

In some cases, at 625, the UE 115-b may resolve, at a second time subsequent to the first time, one or more second SBFD collisions. In some examples, according to the first SBFD collision type priority order, the UE 115-b may resolve the one or more second SBFD collisions based on the one or more second SBFD collisions being associated with the second SBFD collision type. In such cases, the one or more second SBFD collisions may be based on a second uplink message of the one or more uplink messages at least partially overlapping with a third uplink message of the one or more uplink messages, such that, to resolve the one or more second SBFD collisions, the UE 115-b may either refrain from transmitting the second uplink message based on the third uplink message being associated with a higher priority than the second uplink message or may multiplex the second uplink message into the third uplink message based on the third uplink message being associated with a higher priority than the second uplink message.

In some cases, when the UE 115-b multiplexes the second uplink message into the third uplink message based on the third uplink message being associated with the higher priority than the second uplink message, the UE 115-b may determine whether a third SBFD collision of one or more third SBFD collisions is resolved based on multiplexing the third uplink message, where the third SBFD collision is based on a second downlink message overlapping at least partially with the second uplink message. In some cases, the third SBFD collision may not be resolved based on one or more first symbols of the multiplexed uplink message overlapping at least partially with the second downlink message, where the one or more first symbols are associated with the second uplink message. In some other cases, the third SBFD collision may be resolved based on one or more second symbols of the multiplexed uplink message being exclusive of the second downlink message, where the one or more second symbols are associated with the third uplink message.

In some other examples, according to the second SBFD collision type priority order, the UE 115-b may resolve the one or more second SBFD collisions based on the one or more second SBFD collisions being associated with the third SBFD collision type. In such cases, the one or more second SBFD collisions may be based on a fourth uplink message of the one or more uplink messages at least partially overlapping with a third downlink message of the one or more downlink messages. In such cases, a set of collision symbols associated with the fourth uplink message may be based on one or more time domain resources allocated for the fourth uplink message that overlap with the third downlink message, all symbols associated with the fourth uplink message, a quantity of symbols prior to a transmission time of the fourth uplink message, or any combination thereof.

In some other examples, according to the third SBFD collision type priority order, the UE 115-b may resolve the one or more second SBFD collisions based on the one or more second SBFD collisions being associated with the first SBFD collision type. In some cases, when the first link direction is uplink the UE 115-b may resolve the one or more second SBFD collisions by refraining from transmitting at least a portion of the one or more uplink messages via the SBFD symbol, where the at least portion of the one or more uplink messages overlaps with the one or more downlink sub-bands (e.g., extends outside of usable uplink PRBs). In some other cases, when the first link direction is downlink, the UE 115-b may resolve the one or more second SBFD collisions by refraining from receiving at least a portion of the one or more downlink messages via the SBFD symbol, where the at least portion of the one or more downlink messages overlaps with the one or more uplink sub-bands (e.g., extends outside of usable downlink PRBs).

In some cases, at 630, the UE 115-b may resolve, at a third time subsequent to the second time, the one or more third SBFD collisions. In some examples, according to the first SBFD collision type priority order, the UE 115-b may resolve the one or more third SBFD collisions based on the one or more third SBFD collisions being associated with the third SBFD collision type. In such cases, the one or more third SBFD collisions may be based on the fourth uplink message of the one or more uplink messages at least partially overlapping with the third downlink message of the one or more downlink messages.

In some other examples, according to the second SBFD collision type priority order or according to the third SBFD collision type priority order when the first link direction is uplink, the UE 115-b may resolve the one or more third SBFD collisions based on the one or more third SBFD collisions being associated with the second SBFD collision type. In such cases, the one or more third SBFD collisions may be based on the second uplink message of the one or more uplink messages at least partially overlapping with the third uplink message of the one or more uplink messages, such that, to resolve the one or more third SBFD collisions, the UE 115-b may either refrain from transmitting the second uplink message based on the third uplink message being associated with the higher priority than the second uplink message or may multiplex the second uplink message into the third uplink message based at least in part on the third uplink message being associated with a higher priority than the second uplink message.

At 635, the UE 115-b may communicate (e.g., transmit, receive), via the SBFD symbol, at least a fifth subset of the multiple messages based on resolving the multiple SBFD collisions in accordance with the first SBFD collision type priority order, the second SBFD collision type priority, the third SBFD collision type priority, or any combination thereof.

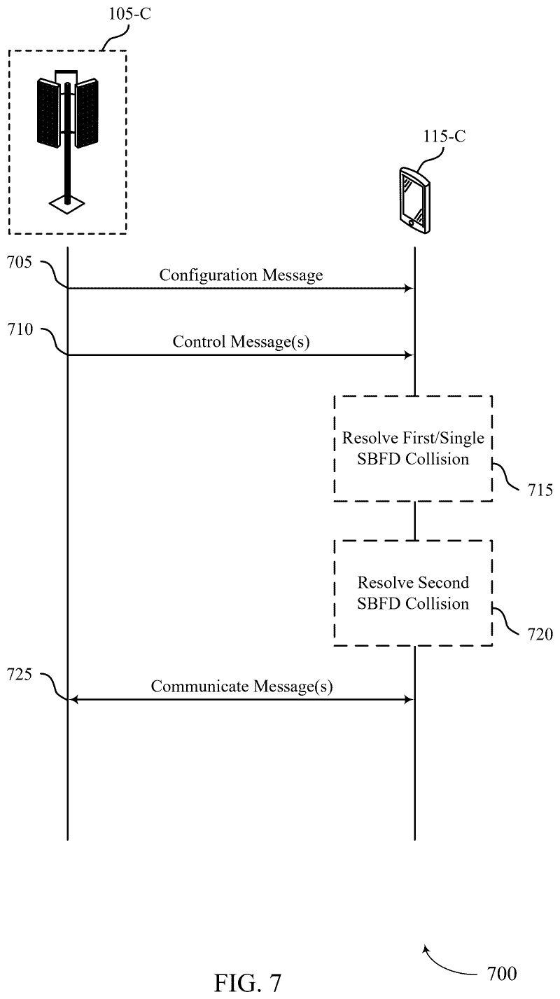

FIG. 7 shows an example of a process flow 700 that supports techniques for resolving multiple collisions in SBFD symbols in accordance with one or more aspects of the present disclosure. In some cases, the process flow 700 may implement or be implemented by aspects of the wireless communications system 100, the wireless communications system 200, the SBFD collision scenarios 300, the SBFD collision scenario 400, the SBFD collision scenarios 500, the process flow 600, or any combination thereof. For example, the process flow 700 may include one or more UEs 115 (e.g., a UE 115-c) and one or more network entities 105 (e.g., a network entity 105-c), which may be examples of the corresponding devices as described herein. In the following description of the process flow 700, the operations between the UE 115-c and the network entity 105-c may be transmitted in a different order than the example order shown, or the operations performed by the UE 115-c and the network entity 105-c may be performed in different orders or at different times. Some operations may also be omitted from the process flow 600, and other operations may be added to the process flow 700.

At 705, the UE 115-c (e.g., a half-duplex UE 115-c, an SBFD-aware UE 115-c) may receive, from the network entity 105-c, a configuration message (e.g., control message) indicating one or more SBFD symbols for the network entity 105-c (e.g., operating according to an SBFD mode, an SBFD network entity 105-c), where each SBFD symbol of the one or more SBFD symbols includes one or more uplink sub-bands and one or more downlink sub-bands (e.g., and one or more guard bands).

At 710, the UE 115-c may receive one or more control messages scheduling multiple messages during an SBFD symbol of the one or more SBFD symbols. In such cases, the multiple messages may include a first message associated with a first transmission direction (e.g., uplink or downlink) and multiple second messages associated with a second transmission direction (e.g., downlink or uplink, respectively) different than (e.g., opposite) the first transmission direction, where the multiple second messages are multiplexed in a time domain (e.g., are TDM ed) or a frequency domain (e.g., are FDM ed) and at least partially overlap with the first message in the time domain.

In some cases, the multiple second messages may be multiplexed in the time domain, and, according to a first SBFD collision rule of one or more SBFD collision rules, a first SBFD collision of the multiple SBFD collisions may be based on a first portion of the first message overlapping with a second message of the multiple second messages and a second SBFD collision of the multiple SBFD collisions may be based on a second portion of the first message overlapping with another second message of the multiple second messages.

In some other cases, according to a second SBFD collision rule of the one or more SBFD collision rules, a single SBFD collision may be based on the first message overlapping with the multiple second messages (e.g., regardless of whether the multiple second messages are multiplexed in the time domain or the frequency domain).

In some cases, at 715, according to the first SBFD collision rule, the UE 115-c may resolve the first SBFD collision based on the second message of the multiple second messages being scheduled to be communicated before the other second message. In some examples, the UE 115-c may resolve the first SBFD collision by refraining from communicating the first message. In such cases, the second SBFD collision may be resolved based on refraining from communicating the first message. In some other examples, the UE 115-c may resolve the first SBFD collision by refraining from communicating the second message of the multiple second messages.

In some other cases, according to the second BFD collision rule, the UE 115-c may resolve the single SBFD collision based on a comparison between a first priority associated with the first message and a second priority associated with the multiple second messages. In such cases, the second priority may be a highest priority among the multiple second messages, may be based on a first occurring second message of the multiple second messages, or both. In some cases, the first transmission direction may be uplink, the second transmission direction may be downlink, and the multiple second messages may include an SSB, such that resolving the single SBFD collision may be based on one or more third SBFD collision rules associated with SSBs (e.g., of the one or more SBFD collision rules).

In some cases, at 720, according to the first SBFD collision rule, the UE 115-c may resolve the second SBFD collision by refraining from communicating a second portion of the first message based on the second portion overlapping with the other second message of the multiple second messages. In some examples, the first transmission direction may be uplink, such that refraining from communicating the second portion may be based on an amount of time for uplink cancellation associated with the UE 115-c, a capability of the UE 115-c to support partial uplink cancellation, or both. In some other cases, the UE 115-c may resolve the second SBFD collision by refraining from communicating the other second message of the multiple second messages.

At 725, the UE 115-c may communicate, via the SBFD symbol, at least a subset of the multiple messages in accordance with the one or more SBFD collision rules.

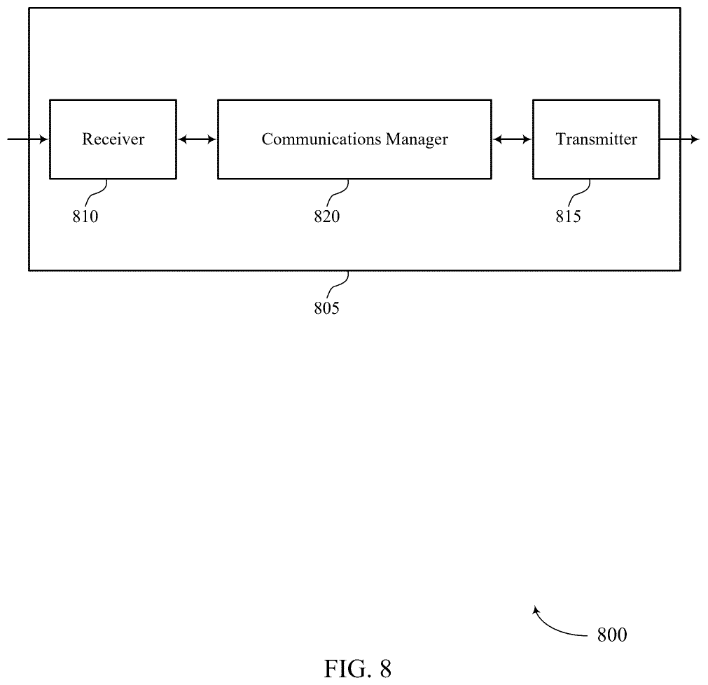

FIG. 8 shows a block diagram 800 of a device 805 that supports techniques for resolving multiple collisions in SBFD symbols in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for resolving multiple collisions in SBFD symbols). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for resolving multiple collisions in SBFD symbols). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of techniques for resolving multiple collisions in SBFD symbols as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an A SIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The communications manager 820 is capable of, configured to, or operable to support a means for receiving one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol. The communications manager 820 is capable of, configured to, or operable to support a means for communicating, via the SBFD symbol, at least a fifth subset of the set of multiple messages based on resolving the set of multiple SBFD collisions in accordance with an SBFD collision type priority order.

Additionally, or alternatively, the communications manager 820 may support wireless communications in accordance with examples as disclosed herein. For example, the communications manager 820 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The communications manager 820 is capable of, configured to, or operable to support a means for receiving one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message. The communications manager 820 is capable of, configured to, or operable to support a means for communicating, via the SBFD symbol, at least a subset of the set of multiple messages in accordance with one or more SBFD collision rules.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for SBFD collision resolution, which may result in reduced processing, reduced power consumption, and more efficient utilization of communication resources, among other examples.

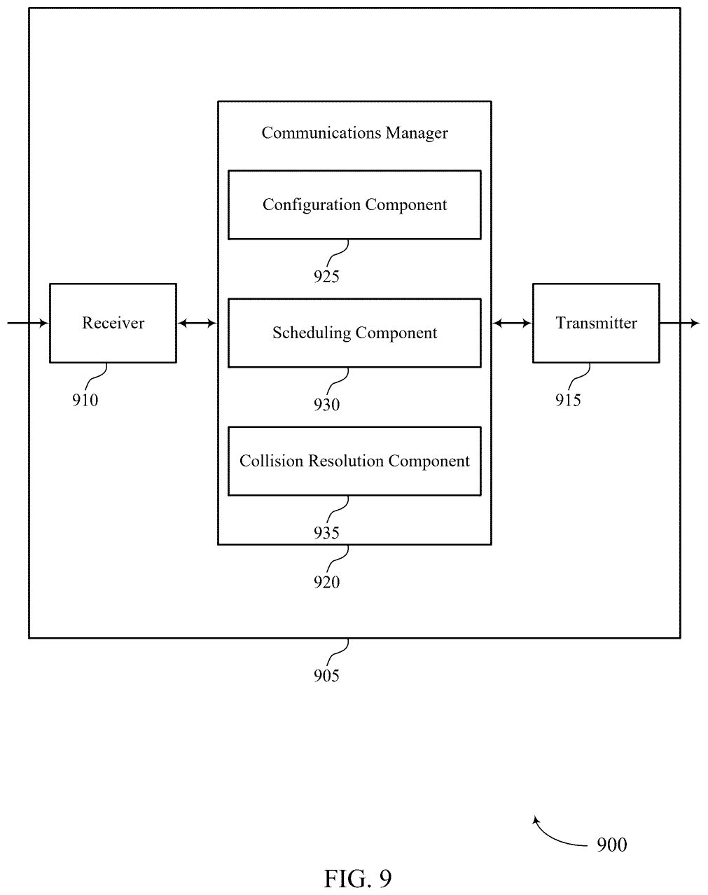

FIG. 9 shows a block diagram 900 of a device 905 that supports techniques for resolving multiple collisions in SBFD symbols in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for resolving multiple collisions in SBFD symbols). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for resolving multiple collisions in SBFD symbols). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for resolving multiple collisions in SBFD symbols as described herein. For example, the communications manager 920 may include a configuration component 925, a scheduling component 930, a collision resolution component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration component 925 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The scheduling component 930 is capable of, configured to, or operable to support a means for receiving one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol. The collision resolution component 935 is capable of, configured to, or operable to support a means for communicating, via the SBFD symbol, at least a fifth subset of the set of multiple messages based on resolving the set of multiple SBFD collisions in accordance with an SBFD collision type priority order.

Additionally, or alternatively, the communications manager 920 may support wireless communications in accordance with examples as disclosed herein. The configuration component 925 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The scheduling component 930 is capable of, configured to, or operable to support a means for receiving one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message. The collision resolution component 935 is capable of, configured to, or operable to support a means for communicate, via the SBFD symbol, at least a subset of the set of multiple messages in accordance with one or more SBFD collision rules.

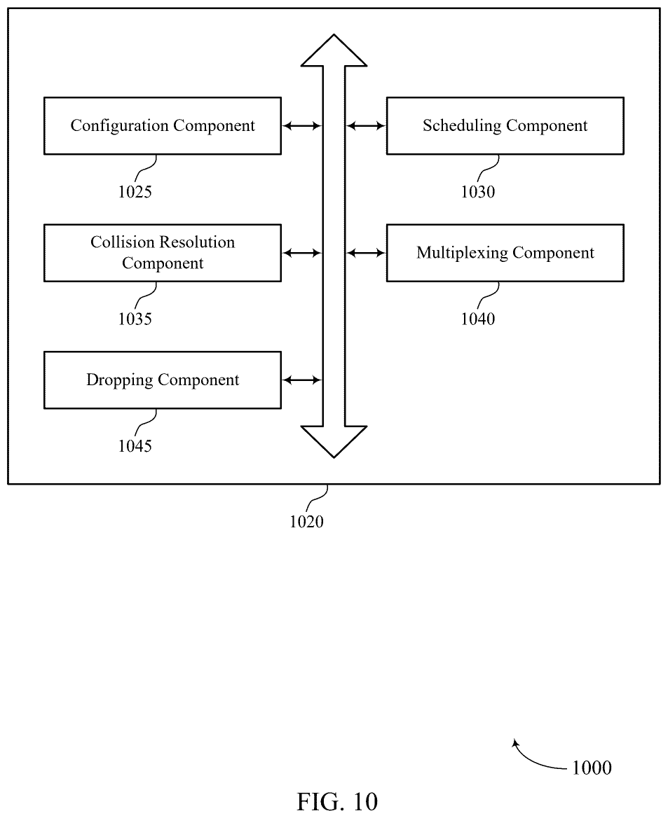

FIG. 10 shows a block diagram 1000 of a communications manager 1020 that supports techniques for resolving multiple collisions in SBFD symbols in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for resolving multiple collisions in SBFD symbols as described herein. For example, the communications manager 1020 may include a configuration component 1025, a scheduling component 1030, a collision resolution component 1035, a multiplexing component 1040, a dropping component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The configuration component 1025 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The scheduling component 1030 is capable of, configured to, or operable to support a means for receiving one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol. The collision resolution component 1035 is capable of, configured to, or operable to support a means for communicating, via the SBFD symbol, at least a fifth subset of the set of multiple messages based on resolving the set of multiple SBFD collisions in accordance with an SBFD collision type priority order.

In some examples, the collision resolution component 1035 is capable of, configured to, or operable to support a means for resolving, at a first time, one or more first SBFD collisions from the set of multiple SBFD collisions in accordance with the SBFD collision type priority order based on the one or more first SBFD collisions being associated with the first SBFD collision type, where communicating the at least a fifth subset of the set of multiple messages is based on resolving the one or more first SBFD collisions.

In some examples, the one or more first SBFD collisions may be based on a first uplink message of the one or more uplink messages at least partially overlapping with one or more resources outside of the one or more uplink sub-bands, such that to support resolving the one or more first SBFD collisions from the set of multiple SBFD collisions, the dropping component 1045 is capable of, configured to, or operable to support a means for refraining from transmitting at least a portion of the first uplink message via the SBFD symbol based on the at least portion of the first uplink message overlapping with the one or more resources outside of the one or more uplink sub-bands, where the at least fifth subset of the set of multiple messages excludes the at least portion of the first uplink message.

In some examples, the one or more first SBFD collisions may be based on a first downlink message of the one or more downlink messages at least partially overlapping with one or more resources outside of the one or more downlink sub-bands, such that to support resolving the one or more first SBFD collisions from the set of multiple SBFD collisions, the dropping component 1045 is capable of, configured to, or operable to support a means for refraining from receiving at least a portion of the first downlink message via the SBFD symbol based on the at least portion of the first downlink message overlapping with the one or more resources outside of the one or more downlink sub-bands, where the at least fifth subset of the set of multiple messages excludes the at least portion of the first downlink message.

In some examples, the collision resolution component 1035 is capable of, configured to, or operable to support a means for resolving, at a second time subsequent to the first time, one or more second SBFD collisions from the set of multiple SBFD collisions in accordance with the SBFD collision type priority order based on the one or more second SBFD collisions being associated with the second SBFD collision type. In some examples, the collision resolution component 1035 is capable of, configured to, or operable to support a means for resolving, at a third time subsequent to the second time, one or more third SBFD collisions from the set of multiple SBFD collisions in accordance with the SBFD collision type priority order based on the one or more third SBFD collisions being associated with the third SBFD collision type, where communicating the at least a fifth subset of the set of multiple messages is based on resolving the one or more second SBFD collisions and the one or more third SBFD collisions.

In some examples, the one or more second SBFD collisions may be based on a first uplink message of the one or more uplink messages at least partially overlapping in the SBFD symbol with a second uplink message of the one or more uplink messages, such that to support resolving the one or more second SBFD collisions, the dropping component 1045 is capable of, configured to, or operable to support a means for refraining from transmitting the first uplink message based on the second uplink message being associated with a higher priority than the first uplink message. In some examples, to support resolving the one or more second SBFD collisions, the multiplexing component 1040 is capable of, configured to, or operable to support a means for multiplexing the first uplink message into the second uplink message based on the second uplink message being associated with a higher priority than the first uplink message.

In some examples, the one or more third SBFD collisions are based on a first uplink message of the one or more uplink messages at least partially overlapping with a first downlink message of the one or more downlink messages. In some examples, a set of collision symbols associated with the first uplink message is based on one or more time domain resources allocated for the first uplink message that overlap with the first downlink message, all symbols associated with the first uplink message, a quantity of symbols prior to a transmission time of the first uplink message, or any combination thereof.

In some examples, the collision resolution component 1035 is capable of, configured to, or operable to support a means for resolving, at a second time subsequent to the first time, one or more second SBFD collisions from the set of multiple SBFD collisions in accordance with the SBFD collision type priority order based on the one or more second SBFD collisions being associated with the third SBFD collision type. In some examples, the collision resolution component 1035 is capable of, configured to, or operable to support a means for resolving, at a third time subsequent to the second time, one or more third SBFD collisions from the set of multiple SBFD collisions in accordance with the SBFD collision type priority order based on the one or more third SBFD collisions being associated with the second SBFD collision type, where communicating the at least a fifth subset of the set of multiple messages is based on resolving the one or more second SBFD collisions and the one or more third SBFD collisions.

In some examples, the one or more third SBFD collisions may be based on a first uplink message of the one or more uplink messages at least partially overlapping with a second uplink message of the one or more uplink messages, such that to support resolving the one or more third SBFD collisions, the dropping component 1045 is capable of, configured to, or operable to support a means for refraining from transmitting the first uplink message based on the second uplink message being associated with a higher priority than the first uplink message. In some examples, to support resolving the one or more third SBFD collisions, the multiplexing component 1040 is capable of, configured to, or operable to support a means for multiplexing the first uplink message into the second uplink message based on the second uplink message being associated with a higher priority than the first uplink message.

In some examples, the configuration component 1025 is capable of, configured to, or operable to support a means for receiving a second control message indicating the second transmission direction associated with the SBFD symbol.

In some examples, the collision resolution component 1035 is capable of, configured to, or operable to support a means for resolving, at a first time, one or more first SBFD collisions from the set of multiple SBFD collisions based on the one or more first SBFD collisions being associated with the fourth SBFD collision type. In some examples, the collision resolution component 1035 is capable of, configured to, or operable to support a means for resolving, at a second time subsequent to the first time, one or more second SBFD collisions from the set of multiple SBFD collisions based on the one or more second SBFD collisions being associated with the first SBFD collision type, where communicating the at least a fifth subset of the set of multiple messages is based on resolving the one or more first SBFD collisions and the one or more second SBFD collisions.

In some examples, to support resolving the one or more first SBFD collisions, the dropping component 1045 is capable of, configured to, or operable to support a means for refraining from receiving the one or more downlink messages based on the second transmission direction being uplink. In some examples, to support resolving the one or more first SBFD collisions, the dropping component 1045 is capable of, configured to, or operable to support a means for refraining from transmitting the one or more uplink messages based on the second transmission direction being downlink.

In some examples, to support resolving the one or more second SBFD collisions, the dropping component 1045 is capable of, configured to, or operable to support a means for refraining from transmitting at least a portion of the one or more uplink messages via the SBFD symbol based on the second transmission direction being uplink, where the at least portion of the one or more uplink messages overlaps with the one or more downlink sub-bands, and where the at least fifth subset of the set of multiple messages excludes the at least portion of the one or more uplink messages. In some examples, to support resolving the one or more second SBFD collisions, the dropping component 1045 is capable of, configured to, or operable to support a means for refraining from receiving at least a portion of the one or more downlink messages via the SBFD symbol based on the second transmission direction being downlink, where the at least portion of the one or more downlink messages overlaps with the one or more uplink sub-bands, and where the at least fifth subset of the set of multiple messages excludes the at least portion of the one or more downlink messages.

In some examples, the second transmission direction is uplink, and the collision resolution component 1035 is capable of, configured to, or operable to support a means for resolving, at a third time subsequent to the second time, one or more third SBFD collisions from the set of multiple SBFD collisions based on the one or more third SBFD collisions being associated with the second SBFD collision type, where communicating the at least a fifth subset of the set of multiple messages is based on resolving the one or more third SBFD collisions.

In some examples, the one or more uplink messages may include at least a first uplink message and a second uplink message, and the one or more third SBFD collisions may be based on the first uplink message at least partially overlapping in the SBFD symbol with the second uplink message, such that to support resolving the one or more third SBFD collisions, the dropping component 1045 is capable of, configured to, or operable to support a means for refraining from transmitting the first uplink message based on the second uplink message being associated with a higher priority than the first uplink message. In some examples, to support resolving the one or more third SBFD collisions, the multiplexing component 1040 is capable of, configured to, or operable to support a means for multiplexing the first uplink message into the second uplink message based on the second uplink message being associated with a higher priority than the first uplink message.

In some examples, the set of multiple messages includes a first uplink message of the one or more uplink messages, and the multiplexing component 1040 is capable of, configured to, or operable to support a means for multiplexing the first uplink message onto the second uplink message to generate a multiplexed uplink message based on the first uplink message overlapping at least partially with the second uplink message. In some examples, the set of multiple messages includes a first uplink message of the one or more uplink messages, and the collision resolution component 1035 is capable of, configured to, or operable to support a means for determining whether the second SBFD collision is resolved based on the multiplexed uplink message.

In some examples, the second SBFD collision is not resolved based on one or more symbols of the multiplexed uplink message overlapping at least partially with the first downlink message. In some examples, the one or more symbols are associated with the first uplink message.

In some examples, the second SBFD collision is resolved based on one or more symbols of the multiplexed uplink message being exclusive of the first downlink message. In some examples, the one or more symbols are associated with the second uplink message.

Additionally, or alternatively, the communications manager 1020 may support wireless communications in accordance with examples as disclosed herein. In some examples, the configuration component 1025 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. In some examples, the scheduling component 1030 is capable of, configured to, or operable to support a means for receiving one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message. In some examples, the collision resolution component 1035 is capable of, configured to, or operable to support a means for communicate, via the SBFD symbol, at least a subset of the set of multiple messages in accordance with one or more SBFD collision rules.

In some examples, the set of multiple second messages are multiplexed in the time domain. In some examples, a first SBFD collision of a set of multiple SBFD collisions is based on a first portion of the first message overlapping with a second message of the set of multiple second messages and a second SBFD collision of the set of multiple SBFD collisions is based on a second portion of the first message overlapping with another second message of the set of multiple second messages.

In some examples, to support resolving the set of multiple SBFD collisions, the collision resolution component 1035 is capable of, configured to, or operable to support a means for resolving the first SBFD collision based on the second message of the set of multiple second messages being scheduled to be communicated before the other second message.

In some examples, to support resolving the first SBFD collision, the dropping component 1045 is capable of, configured to, or operable to support a means for refraining from communicating the first message, where the second SBFD collision is resolved based on refraining from communicating the first message, and where the at least subset of the set of multiple messages includes the set of multiple second messages and excludes the first message.

In some examples, to support resolving the first SBFD collision, the dropping component 1045 is capable of, configured to, or operable to support a means for refraining from communicating the second message of the set of multiple second messages, where the at least subset of the set of multiple messages excludes the second message of the set of multiple second messages.

In some examples, to support resolving the second SBFD collision, the dropping component 1045 is capable of, configured to, or operable to support a means for refraining from communicating a second portion of the first message based on the second portion overlapping with the other second message of the set of multiple second messages, where the at least subset of the set of multiple messages excludes the second portion of the first message and includes both a first portion of the first message and the other second message of the set of multiple second messages.

In some examples, the first transmission direction is uplink. In some examples, refraining from communicating the second portion of the first message is based on an amount of time for uplink cancellation associated with the UE, a capability of the UE to support partial uplink cancellation, or both.

In some examples, to support resolving the second SBFD collision, the dropping component 1045 is capable of, configured to, or operable to support a means for refraining from communicating the other second message of the set of multiple second messages, where the at least subset of the set of multiple messages excludes the other second message of the set of multiple second messages and includes the first message.

In some examples, a single SBFD collision is based on the first message overlapping with the set of multiple second messages.

In some examples, resolving the single SBFD collision is based on a comparison between a first priority associated with the first message and a second priority associated with the set of multiple second messages.

In some examples, the second priority is a highest priority among the set of multiple second messages.

In some examples, the second priority is based on a first occurring second message of the set of multiple second messages.

In some examples, the set of multiple second messages are multiplexed in the time domain.

In some examples, the set of multiple second messages are multiplexed in the frequency domain.

In some examples, the first transmission direction is uplink. In some examples, the second transmission direction is downlink. In some examples, the set of multiple second messages includes a synchronization signal block. In some examples, resolving the single SBFD collision is based on one or more SBFD collision rules associated with synchronization signal blocks.

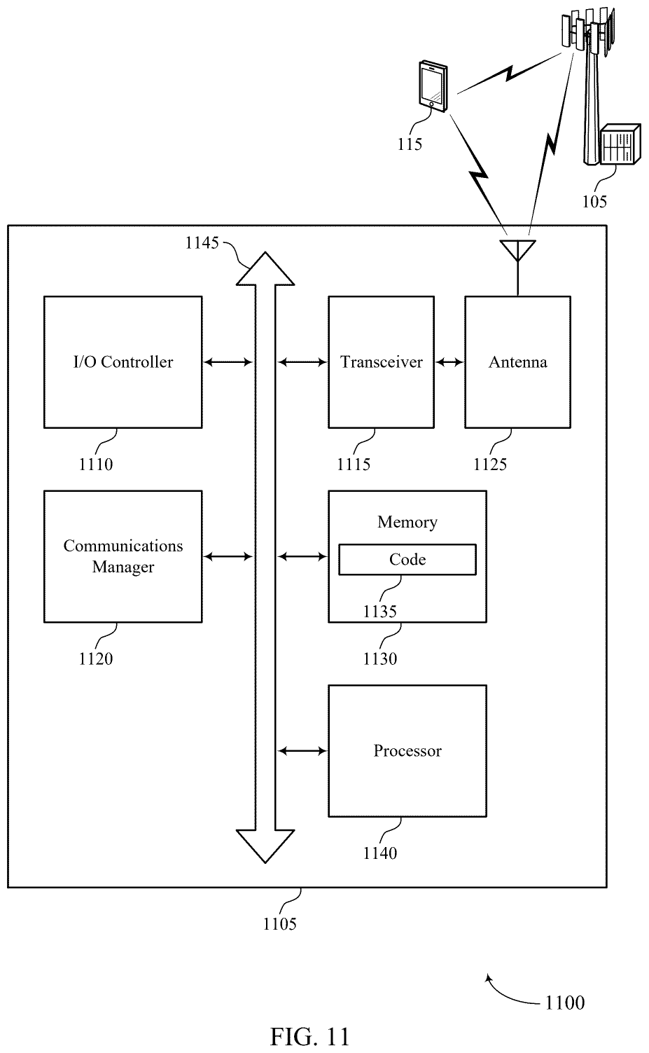

FIG. 11 shows a diagram of a system 1100 including a device 1105 that supports techniques for resolving multiple collisions in SBFD symbols in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more A SICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting techniques for resolving multiple collisions in SBFD symbols). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The communications manager 1120 is capable of, configured to, or operable to support a means for receiving one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol. The communications manager 1120 is capable of, configured to, or operable to support a means for communicating, via the SBFD symbol, at least a fifth subset of the set of multiple messages based on resolving the set of multiple SBFD collisions in accordance with an SBFD collision type priority order.

Additionally, or alternatively, the communications manager 1120 may support wireless communications in accordance with examples as disclosed herein. For example, the communications manager 1120 is capable of, configured to, or operable to support a means for receiving a configuration message indicating one or more sub-band full-duplex (SBFD) symbols for a network entity, where each SBFD symbol of the one or more SBFD symbols includes one or more uplink sub-bands and one or more downlink sub-bands. The communications manager 1120 is capable of, configured to, or operable to support a means for receiving one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message. The communications manager 1120 is capable of, configured to, or operable to support a means for communicating, via the SBFD symbol, at least a subset of the set of multiple messages in accordance with one or more SBFD collision rules.

By including or configuring the communications manager 1120 in accordance with examples as described herein, the device 1105 may support techniques for SBFD collision resolution, which may result in improved communication reliability, reduced latency, improved user experience related to reduced processing, reduced power consumption, more efficient utilization of communication resources, improved coordination between devices, longer battery life, improved utilization of processing capability, among other advantages.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of techniques for resolving multiple collisions in SBFD symbols as described herein, or the at least one processor 1140 and the at least one memory 1130 may be otherwise configured to, individually or collectively, perform or support such operations.

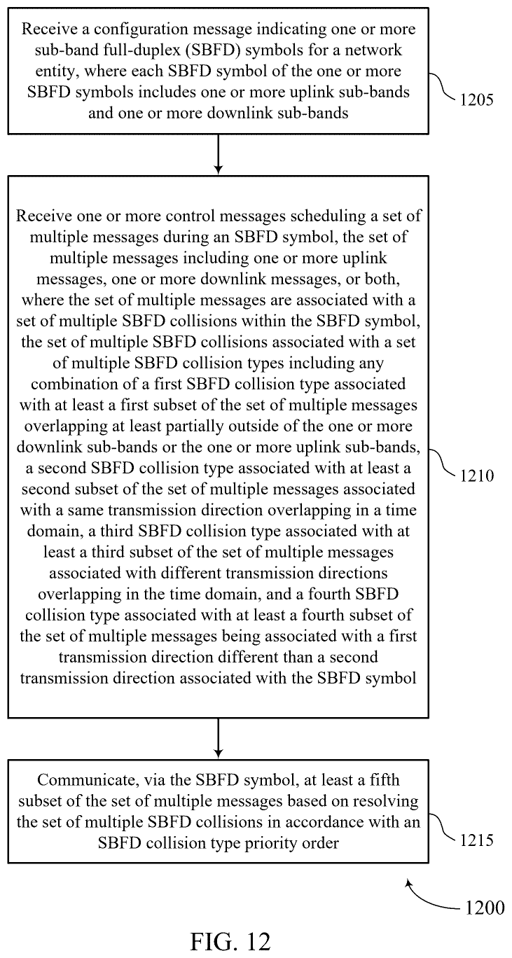

FIG. 12 shows a flowchart illustrating a method 1200 that supports techniques for resolving multiple collisions in SBFD symbols in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a configuration message indicating one or more sub-band full-duplex (SBFD) symbols for a network entity, where each SBFD symbol of the one or more SBFD symbols includes one or more uplink sub-bands and one or more downlink sub-bands. The operations of 1205 may be performed in accordance with examples as disclosed herein. In some examples, aspects of the operations of 1205 may be performed by a configuration component 1025 as described with reference to FIG. 10.

At 1210, the method may include receiving one or more control messages scheduling a set of multiple messages during an SBFD symbol, the set of multiple messages including one or more uplink messages, one or more downlink messages, or both, where the set of multiple messages are associated with a set of multiple SBFD collisions within the SBFD symbol, the set of multiple SBFD collisions associated with a set of multiple SBFD collision types including any combination of a first SBFD collision type associated with at least a first subset of the set of multiple messages overlapping at least partially outside of the one or more downlink sub-bands or the one or more uplink sub-bands, a second SBFD collision type associated with at least a second subset of the set of multiple messages associated with a same transmission direction overlapping in a time domain, a third SBFD collision type associated with at least a third subset of the set of multiple messages associated with different transmission directions overlapping in the time domain, and a fourth SBFD collision type associated with at least a fourth subset of the set of multiple messages being associated with a first transmission direction different than a second transmission direction associated with the SBFD symbol. The operations of 1210 may be performed in accordance with examples as disclosed herein. In some examples, aspects of the operations of 1210 may be performed by a scheduling component 1030 as described with reference to FIG. 10.

At 1215, the method may include communicating, via the SBFD symbol, at least a fifth subset of the set of multiple messages based on resolving the set of multiple SBFD collisions in accordance with an SBFD collision type priority order. The operations of 1215 may be performed in accordance with examples as disclosed herein. In some examples, aspects of the operations of 1215 may be performed by a collision resolution component 1035 as described with reference to FIG. 10.

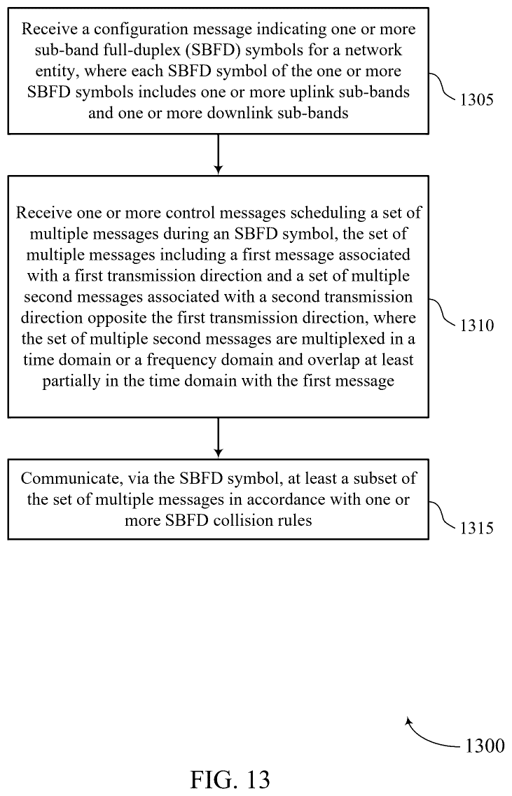

FIG. 13 shows a flowchart illustrating a method 1300 that supports techniques for resolving multiple collisions in SBFD symbols in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving a configuration message indicating one or more sub-band full-duplex (SBFD) symbols for a network entity, where each SBFD symbol of the one or more SBFD symbols includes one or more uplink sub-bands and one or more downlink sub-bands. The operations of 1305 may be performed in accordance with examples as disclosed herein. In some examples, aspects of the operations of 1305 may be performed by a configuration component 1025 as described with reference to FIG. 10.

At 1310, the method may include receiving one or more control messages scheduling a set of multiple messages during an SBFD symbol, the set of multiple messages including a first message associated with a first transmission direction and a set of multiple second messages associated with a second transmission direction opposite the first transmission direction, where the set of multiple second messages are multiplexed in a time domain or a frequency domain and overlap at least partially in the time domain with the first message. The operations of 1310 may be performed in accordance with examples as disclosed herein. In some examples, aspects of the operations of 1310 may be performed by a scheduling component 1030 as described with reference to FIG. 10.

At 1315, the method may include communicate, via the SBFD symbol, at least a subset of the set of multiple messages in accordance with one or more SBFD collision rules. The operations of 1315 may be performed in accordance with examples as disclosed herein. In some examples, aspects of the operations of 1315 may be performed by a collision resolution component 1035 as described with reference to FIG. 10.

It should be noted that the methods described herein describe possible implementations. The operations and the steps may be rearranged or otherwise modified and other implementations are possible. Further, aspects from two or more of the methods may be combined.

The following provides an overview of aspects of the present disclosure:

Aspect 1: A method for wireless communications at a half-duplex UE, comprising: receiving a configuration message indicating one or more SBFD symbols for a network entity, wherein each SBFD symbol of the one or more SBFD symbols comprises one or more uplink sub-bands and one or more downlink sub-bands; receiving one or more control messages scheduling a plurality of messages during an SBFD symbol, the plurality of messages including one or more uplink messages, one or more downlink messages, or both, wherein the plurality of messages are associated with a plurality of SBFD collisions within the SBFD symbol, the plurality of SBFD collisions associated with a plurality of SBFD collision types comprising any combination of a first SBFD collision type associated with at least a first subset of the plurality of messages overlapping at least partially outside of the one or more downlink sub-bands or the one or more uplink sub-bands, a second SBFD collision type associated with at least a second subset of the plurality of messages associated with a same transmission direction overlapping in a time domain, a third SBFD collision type associated with at least a third subset of the plurality of messages associated with different transmission directions overlapping in the time domain, and a fourth SBFD collision type associated with at least a fourth subset of the plurality of messages being associated with a first transmission direction different than a second transmission direction associated with the SBFD symbol; and communicating, via the SBFD symbol, at least a fifth subset of the plurality of messages based at least in part on resolving the plurality of SBFD collisions in accordance with an SBFD collision type priority order.

Aspect 2: The method of aspect 1, further comprising: resolving, at a first time, one or more first SBFD collisions from the plurality of SBFD collisions in accordance with the SBFD collision type priority order based at least in part on the one or more first SBFD collisions being associated with the first SBFD collision type, wherein communicating the at least a fifth subset of the plurality of messages is based at least in part on resolving the one or more first SBFD collisions.

Aspect 3: The method of aspect 2, wherein the one or more first SBFD collisions are based at least in part on a first uplink message of the one or more uplink messages at least partially overlapping with one or more resources outside of the one or more uplink sub-bands, wherein resolving the one or more first SBFD collisions from the plurality of SBFD collisions comprises: refraining from transmitting at least a portion of the first uplink message via the SBFD symbol based at least in part on the at least portion of the first uplink message overlapping with the one or more resources outside of the one or more uplink sub-bands, wherein the at least fifth subset of the plurality of messages excludes the at least portion of the first uplink message.

Aspect 4: The method of any of aspects 2 through 3, wherein the one or more first SBFD collisions are based at least in part on a first downlink message of the one or more downlink messages at least partially overlapping with one or more resources outside of the one or more downlink sub-bands, wherein resolving the one or more first SBFD collisions from the plurality of SBFD collisions comprises: refraining from receiving at least a portion of the first downlink message via the SBFD symbol based at least in part on the at least portion of the first downlink message overlapping with the one or more resources outside of the one or more downlink sub-bands, wherein the at least fifth subset of the plurality of messages excludes the at least portion of the first downlink message.

Aspect 5: The method of any of aspects 2 through 4, further comprising: resolving, at a second time subsequent to the first time, one or more second SBFD collisions from the plurality of SBFD collisions in accordance with the SBFD collision type priority order based at least in part on the one or more second SBFD collisions being associated with the second SBFD collision type; and resolving, at a third time subsequent to the second time, one or more third SBFD collisions from the plurality of SBFD collisions in accordance with the SBFD collision type priority order based at least in part on the one or more third SBFD collisions being associated with the third SBFD collision type, wherein communicating the at least a fifth subset of the plurality of messages is based at least in part on resolving the one or more second SBFD collisions and the one or more third SBFD collisions.

Aspect 6: The method of aspect 5, wherein the one or more second SBFD collisions are based at least in part on a first uplink message of the one or more uplink messages at least partially overlapping in the SBFD symbol with a second uplink message of the one or more uplink messages, and wherein resolving the one or more second SBFD collisions comprises: refraining from transmitting the first uplink message based at least in part on the second uplink message being associated with a higher priority than the second uplink message; or multiplexing the first uplink message into the second uplink message based at least in part on the second uplink message being associated with a higher priority than the second uplink message.

Aspect 7: The method of any of aspects 5 through 6, wherein the one or more third SBFD collisions are based at least in part on a first uplink message of the one or more uplink messages at least partially overlapping with a first downlink message of the one or more downlink messages, and a set of collision symbols associated with the first uplink message is based at least in part on one or more time domain resources allocated for the first uplink message that overlap with the first downlink message, all symbols associated with the first uplink message, a quantity of symbols prior to a transmission time of the first uplink message, or any combination thereof.

Aspect 8: The method of any of aspects 2 through 7, further comprising: resolving, at a second time subsequent to the first time, one or more second SBFD collisions from the plurality of SBFD collisions in accordance with the SBFD collision type priority order based at least in part on the one or more second SBFD collisions being associated with the third SBFD collision type; and resolving, at a third time subsequent to the second time, one or more third SBFD collisions from the plurality of SBFD collisions in accordance with the SBFD collision type priority order based at least in part on the one or more third SBFD collisions being associated with the second SBFD collision type, wherein communicating the at least a fifth subset of the plurality of messages is based at least in part on resolving the one or more second SBFD collisions and the one or more third SBFD collisions.

Aspect 9: The method of aspect 8, wherein the one or more third SBFD collisions are based at least in part on a first uplink message of the one or more uplink messages at least partially overlapping with a second uplink message of the one or more uplink messages, and wherein resolving the one or more third SBFD collisions comprises: refraining from transmitting the first uplink message based at least in part on the second uplink message being associated with a higher priority than the second uplink message; or multiplexing the first uplink message into the second uplink message based at least in part on the second uplink message being associated with a higher priority than the second uplink message.

Aspect 10: The method of any of aspects 1 through 9, further comprising: receiving a second control message indicating the second transmission direction associated with the SBFD symbol.

Aspect 11: The method of aspect 10, further comprising: resolving, at a first time, one or more first SBFD collisions from the plurality of SBFD collisions based at least in part on the one or more first SBFD collisions being associated with the fourth SBFD collision type; and resolving, at a second time subsequent to the first time, one or more second SBFD collisions from the plurality of SBFD collisions based at least in part on the one or more second SBFD collisions being associated with the first SBFD collision type, wherein communicating the at least a fifth subset of the plurality of messages is based at least in part on resolving the one or more first SBFD collisions and the one or more second SBFD collisions.

Aspect 12: The method of aspect 11, wherein resolving the one or more first SBFD collisions comprises: refraining from receiving the one or more downlink messages based at least in part on the second transmission direction being uplink; or refraining from transmitting the one or more uplink messages based at least in part on the second transmission direction being downlink.

Aspect 13: The method of any of aspects 11 through 12, wherein resolving the one or more second SBFD collisions comprises: refraining from transmitting at least a portion of the one or more uplink messages via the SBFD symbol based at least in part on the second transmission direction being uplink, wherein the at least portion of the one or more uplink messages overlaps with the one or more downlink sub-bands, and wherein the at least fifth subset of the plurality of messages excludes the at least portion of the one or more uplink messages; or refraining from receiving at least a portion of the one or more downlink messages via the SBFD symbol based at least in part on the second transmission direction being downlink, wherein the at least portion of the one or more downlink messages overlaps with the one or more uplink sub-bands, and wherein the at least fifth subset of the plurality of messages excludes the at least portion of the one or more downlink messages.

Aspect 14: The method of any of aspects 11 through 13, wherein the second transmission direction is uplink, the method further comprising: resolving, at a third time subsequent to the second time, one or more third SBFD collisions from the plurality of SBFD collisions based at least in part on the one or more third SBFD collisions being associated with the second SBFD collision type, wherein communicating the at least a fifth subset of the plurality of messages is based at least in part on resolving the one or more third SBFD collisions.

Aspect 15: The method of aspect 14, wherein the one or more uplink messages comprises at least a first uplink message and a second uplink message, wherein the one or more third SBFD collisions are based at least in part on the first uplink message at least partially overlapping in the SBFD symbol with the second uplink message, and wherein resolving the one or more third SBFD collisions comprises: refraining from transmitting the first uplink message based at least in part on the second uplink message being associated with a higher priority than the second uplink message; or multiplexing the first uplink message into the second uplink message based at least in part on the second uplink message being associated with a higher priority than the second uplink message.

Aspect 16: The method of any of aspects 1 through 15, wherein the plurality of messages comprises a first uplink message of the one or more uplink messages, a second uplink message of the one or more uplink messages, and a first downlink message of the one or more downlink messages, wherein the plurality of SBFD collisions comprises a first SBFD collision associated with the second SBFD collision type based at least in part on the first uplink message overlapping at least partially with the second uplink message and a second SBFD collision associated with the third SBFD collision type based at least in part on the first downlink message overlapping at least partially with the first uplink message, the method further comprising: multiplexing the first uplink message onto the second uplink message to generate a multiplexed uplink message based at least in part on the first uplink message overlapping at least partially with the second uplink message; and determining whether the second SBFD collision is resolved based at least in part on the multiplexed uplink message.

Aspect 17: The method of aspect 16, wherein the second SBFD collision is not resolved based at least in part on one or more symbols of the multiplexed uplink message overlapping at least partially with the first downlink message, and the one or more symbols are associated with the first uplink message.

Aspect 18: The method of any of aspects 16 through 17, wherein the second SBFD collision is resolved based at least in part on one or more symbols of the multiplexed uplink message being exclusive of the first downlink message, and the one or more symbols are associated with the second uplink message.

Aspect 19: A method for wireless communications at a half-duplex UE, comprising: receiving a configuration message indicating one or more SBFD symbols for a network entity, wherein each SBFD symbol of the one or more SBFD symbols comprises one or more uplink sub-bands and one or more downlink sub-bands; receiving one or more control messages scheduling a plurality of messages during an SBFD symbol, the plurality of messages comprising a first message associated with a first transmission direction and a plurality of second messages associated with a second transmission direction opposite the first transmission direction, wherein the plurality of second messages are multiplexed in a time domain or a frequency domain and overlap at least partially in the time domain with the first message; and communicate, via the SBFD symbol, at least a subset of the plurality of messages in accordance with one or more SBFD collision rules.

Aspect 20: The method of aspect 19, wherein the plurality of second messages are multiplexed in the time domain, and a first SBFD collision of a plurality of SBFD collisions is based at least in part on a first portion of the first message overlapping with a second message of the plurality of second messages and a second SBFD collision of the plurality of SBFD collisions is based at least in part on a second portion of the first message overlapping with another second message of the plurality of second messages.

Aspect 21: The method of aspect 20, wherein resolving the plurality of SBFD collisions comprises: resolving the first SBFD collision based at least in part on the second message of the plurality of second messages being scheduled to be communicated before the other second message.

Aspect 22: The method of aspect 21, wherein resolving the first SBFD collision comprises: refraining from communicating the first message, wherein the second SBFD collision is resolved based at least in part on refraining from communicating the first message, and wherein the at least subset of the plurality of messages includes the plurality of second messages and excludes the first message.

Aspect 23: The method of any of aspects 21 through 22, wherein resolving the first SBFD collision comprises: refraining from communicating the second message of the plurality of second messages, wherein the at least subset of the plurality of messages excludes the second message of the plurality of second messages.

Aspect 24: The method of aspect 23, wherein resolving the second SBFD collision comprises: refraining from communicating a second portion of the first message based at least in part on the second portion overlapping with the other second message of the plurality of second messages, wherein the at least subset of the plurality of messages excludes the second portion of the first message and includes both a first portion of the first message and the other second message of the plurality of second messages.

Aspect 25: The method of aspect 24, wherein the first transmission direction is uplink, and refraining from communicating the second portion of the first message is based at least in part on an amount of time for uplink cancellation associated with the UE, a capability of the UE to support partial uplink cancellation, or both.

Aspect 26: The method of any of aspects 23 through 25, wherein resolving the second SBFD collision comprises: refraining from communicating the other second message of the plurality of second messages, wherein the at least subset of the plurality of messages excludes the other second message of the plurality of second messages and includes the first message.

Aspect 27: The method of any of aspects 19 through 26, wherein a single SBFD collision is based at least in part on the first message overlapping with the plurality of second messages.

Aspect 28: The method of aspect 27, wherein resolving the single SBFD collision is based at least in part on a comparison between a first priority associated with the first message and a second priority associated with the plurality of second messages.

Aspect 29: The method of aspect 28, wherein the second priority is a highest priority among the plurality of second messages.

Aspect 30: The method of any of aspects 28 through 29, wherein the second priority is based at least in part on a first occurring second message of the plurality of second messages.

Aspect 31: The method of any of aspects 27 through 30, wherein the plurality of second messages are multiplexed in the time domain.

Aspect 32: The method of any of aspects 27 through 31, wherein the plurality of second messages are multiplexed in the frequency domain.

Aspect 33: The method of aspect 32, wherein the first transmission direction is uplink, the second transmission direction is downlink, the plurality of second messages comprises a synchronization signal block, and resolving the single SBFD collision is based at least in part on one or more SBFD collision rules associated with synchronization signal blocks.

Aspect 34: A half-duplex UE for wireless communications, comprising one or more memories storing processor-executable code, and one or more processors coupled with the one or more memories and individually or collectively operable to execute the code to cause the half-duplex UE to perform a method of any of aspects 1 through 18.

Aspect 35: A half-duplex UE for wireless communications, comprising at least one means for performing a method of any of aspects 1 through 18.

Aspect 36: A non-transitory computer-readable medium storing code for wireless communications, the code comprising instructions executable by one or more processors to perform a method of any of aspects 1 through 18.

Aspect 37: A half-duplex UE for wireless communications, comprising one or more memories storing processor-executable code, and one or more processors coupled with the one or more memories and individually or collectively operable to execute the code to cause the half-duplex UE to perform a method of any of aspects 19 through 33.

Aspect 38: A half-duplex UE for wireless communications, comprising at least one means for performing a method of any of aspects 19 through 33.

Aspect 39: A non-transitory computer-readable medium storing code for wireless communications, the code comprising instructions executable by one or more processors to perform a method of any of aspects 19 through 33.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. A Iso, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A half-duplex user equipment (UE), comprising:
one or more memories storing processor-executable code; and
one or more processors coupled with the one or more memories and individually or collectively operable to execute the code to cause the half-duplex UE to:
receive a configuration message indicating one or more sub-band full-duplex (SBFD) symbols for a network entity, wherein each SBFD symbol of the one or more SBFD symbols comprises one or more uplink sub-bands and one or more downlink sub-bands;
receive one or more control messages scheduling a plurality of messages during an SBFD symbol, the plurality of messages including one or more uplink messages, one or more downlink messages, or both, wherein the plurality of messages are associated with a plurality of SBFD collisions within the SBFD symbol, the plurality of SBFD collisions associated with a plurality of SBFD collision types comprising any combination of a first SBFD collision type associated with at least a first subset of the plurality of messages overlapping at least partially outside of the one or more downlink sub-bands or the one or more uplink sub-bands, a second SBFD collision type associated with at least a second subset of the plurality of messages associated with a same transmission direction overlapping in a time domain, a third SBFD collision type associated with at least a third subset of the plurality of messages associated with different transmission directions overlapping in the time domain, and a fourth SBFD collision type associated with at least a fourth subset of the plurality of messages being associated with a first transmission direction different than a second transmission direction associated with the SBFD symbol; and
communicate, via the SBFD symbol, at least a fifth subset of the plurality of messages based at least in part on resolving the plurality of SBFD collisions in accordance with an SBFD collision type priority order.

2. The half-duplex UE of claim 1, wherein the one or more processors are individually or collectively further operable to execute the code to cause the half-duplex UE to:
resolve, at a first time, one or more first SBFD collisions from the plurality of SBFD collisions in accordance with the SBFD collision type priority order based at least in part on the one or more first SBFD collisions being associated with the first SBFD collision type, wherein communicating the at least a fifth subset of the plurality of messages is based at least in part on resolving the one or more first SBFD collisions.

3. The half-duplex UE of claim 2, wherein the one or more first SBFD collisions are based at least in part on a first uplink message of the one or more uplink messages at least partially overlapping with one or more resources outside of the one or more uplink sub-bands, and wherein, to resolve the one or more first SBFD collisions from the plurality of SBFD collisions, the one or more processors are individually or collectively operable to execute the code to cause the half-duplex UE to:
refrain from transmitting at least a portion of the first uplink message via the SBFD symbol based at least in part on the at least portion of the first uplink message overlapping with the one or more resources outside of the one or more uplink sub-bands, wherein the at least fifth subset of the plurality of messages excludes the at least portion of the first uplink message.

4. The half-duplex UE of claim 2, wherein the one or more first SBFD collisions are based at least in part on a first downlink message of the one or more downlink messages at least partially overlapping with one or more resources outside of the one or more downlink sub-bands, and wherein, to resolve the one or more first SBFD collisions from the plurality of SBFD collisions, the one or more processors are individually or collectively operable to execute the code to cause the half-duplex UE to:
refrain from receiving at least a portion of the first downlink message via the SBFD symbol based at least in part on the at least portion of the first downlink message overlapping with the one or more resources outside of the one or more downlink sub-bands, wherein the at least fifth subset of the plurality of messages excludes the at least portion of the first downlink message.

5. The half-duplex UE of claim 2, wherein the one or more processors are individually or collectively further operable to execute the code to cause the half-duplex UE to:
resolve, at a second time subsequent to the first time, one or more second SBFD collisions from the plurality of SBFD collisions in accordance with the SBFD collision type priority order based at least in part on the one or more second SBFD collisions being associated with the second SBFD collision type; and
resolve, at a third time subsequent to the second time, one or more third SBFD collisions from the plurality of SBFD collisions in accordance with the SBFD collision type priority order based at least in part on the one or more third SBFD collisions being associated with the third SBFD collision type, wherein communicating the at least a fifth subset of the plurality of messages is based at least in part on resolving the one or more second SBFD collisions and the one or more third SBFD collisions.

6. The half-duplex UE of claim 5, wherein the one or more second SBFD collisions are based at least in part on a first uplink message of the one or more uplink messages at least partially overlapping in the SBFD symbol with a second uplink message of the one or more uplink messages, and wherein, to resolve the one or more second SBFD collisions, the one or more processors are individually or collectively operable to execute the code to cause the half-duplex UE to:
refrain from transmitting the first uplink message based at least in part on the second uplink message being associated with a higher priority than the first uplink message; or
multiplex the first uplink message into the second uplink message based at least in part on the second uplink message being associated with a higher priority than the first uplink message.

7. The half-duplex UE of claim 5, wherein the one or more third SBFD collisions are based at least in part on a first uplink message of the one or more uplink messages at least partially overlapping with a first downlink message of the one or more downlink messages, and wherein a set of collision symbols associated with the first uplink message is based at least in part on one or more time domain resources allocated for the first uplink message that overlap with the first downlink message, all symbols associated with the first uplink message, a quantity of symbols prior to a transmission time of the first uplink message, or any combination thereof.

8. The half-duplex UE of claim 2, wherein the one or more processors are individually or collectively further operable to execute the code to cause the half-duplex UE to:
resolve, at a second time subsequent to the first time, one or more second SBFD collisions from the plurality of SBFD collisions in accordance with the SBFD collision type priority order based at least in part on the one or more second SBFD collisions being associated with the third SBFD collision type; and
resolve, at a third time subsequent to the second time, one or more third SBFD collisions from the plurality of SBFD collisions in accordance with the SBFD collision type priority order based at least in part on the one or more third SBFD collisions being associated with the second SBFD collision type, wherein communicating the at least a fifth subset of the plurality of messages is based at least in part on resolving the one or more second SBFD collisions and the one or more third SBFD collisions.

9. The half-duplex UE of claim 8, wherein the one or more third SBFD collisions are based at least in part on a first uplink message of the one or more uplink messages at least partially overlapping with a second uplink message of the one or more uplink messages, and wherein, to resolve the one or more third SBFD collisions, the one or more processors are individually or collectively operable to execute the code to cause the half-duplex UE to:
refrain from transmitting the first uplink message based at least in part on the second uplink message being associated with a higher priority than the first uplink message; or
multiplex the first uplink message into the second uplink message based at least in part on the second uplink message being associated with a higher priority than the first uplink message.

10. The half-duplex UE of claim 1, wherein the one or more processors are individually or collectively further operable to execute the code to cause the half-duplex UE to:
receive a second control message indicating the second transmission direction associated with the SBFD symbol.

11. The half-duplex UE of claim 10, wherein the one or more processors are individually or collectively further operable to execute the code to cause the half-duplex UE to:
resolve, at a first time, one or more first SBFD collisions from the plurality of SBFD collisions based at least in part on the one or more first SBFD collisions being associated with the fourth SBFD collision type; and
resolve, at a second time subsequent to the first time, one or more second SBFD collisions from the plurality of SBFD collisions based at least in part on the one or more second SBFD collisions being associated with the first SBFD collision type, wherein communicating the at least a fifth subset of the plurality of messages is based at least in part on resolving the one or more first SBFD collisions and the one or more second SBFD collisions.

12. The half-duplex UE of claim 11, wherein, to resolve the one or more first SBFD collisions, the one or more processors are individually or collectively operable to execute the code to cause the half-duplex UE to:
refrain from receiving the one or more downlink messages based at least in part on the second transmission direction being uplink; or
refrain from transmitting the one or more uplink messages based at least in part on the second transmission direction being downlink.

13. The half-duplex UE of claim 11, wherein, to resolve the one or more second SBFD collisions, the one or more processors are individually or collectively operable to execute the code to cause the half-duplex UE to:
refrain from transmitting at least a portion of the one or more uplink messages via the SBFD symbol based at least in part on the second transmission direction being uplink, wherein the at least portion of the one or more uplink messages overlaps with the one or more downlink sub-bands, and wherein the at least fifth subset of the plurality of messages excludes the at least portion of the one or more uplink messages; or
refrain from receiving at least a portion of the one or more downlink messages via the SBFD symbol based at least in part on the second transmission direction being downlink, wherein the at least portion of the one or more downlink messages overlaps with the one or more uplink sub-bands, and wherein the at least fifth subset of the plurality of messages excludes the at least portion of the one or more downlink messages.

14. The half-duplex UE of claim 11, wherein the second transmission direction is uplink, and the one or more processors are individually or collectively further operable to execute the code to cause the half-duplex UE to:
resolve, at a third time subsequent to the second time, one or more third SBFD collisions from the plurality of SBFD collisions based at least in part on the one or more third SBFD collisions being associated with the second SBFD collision type, wherein communicating the at least a fifth subset of the plurality of messages is based at least in part on resolving the one or more third SBFD collisions.

15. The half-duplex UE of claim 14, wherein the one or more uplink messages comprises at least a first uplink message and a second uplink message, wherein the one or more third SBFD collisions are based at least in part on the first uplink message at least partially overlapping in the SBFD symbol with the second uplink message, and wherein, to resolve the one or more third SBFD collisions, the one or more processors are individually or collectively operable to execute the code to cause the half-duplex UE to:
refrain from transmitting the first uplink message based at least in part on the second uplink message being associated with a higher priority than the first uplink message; or
multiplex the first uplink message into the second uplink message based at least in part on the second uplink message being associated with a higher priority than the first uplink message.

16. The half-duplex UE of claim 1, wherein the plurality of messages comprises a first uplink message of the one or more uplink messages, a second uplink message of the one or more uplink messages, and a first downlink message of the one or more downlink messages, wherein the plurality of SBFD collisions comprises a first SBFD collision associated with the second SBFD collision type based at least in part on the first uplink message overlapping at least partially with the second uplink message and a second SBFD collision associated with the third SBFD collision type based at least in part on the first downlink message overlapping at least partially with the first uplink message, and the one or more processors are individually or collectively further operable to execute the code to cause the half-duplex UE to:
multiplex the first uplink message onto the second uplink message to generate a multiplexed uplink message based at least in part on the first uplink message overlapping at least partially with the second uplink message; and
determine whether the second SBFD collision is resolved based at least in part on the multiplexed uplink message.

17. The half-duplex UE of claim 16, wherein the second SBFD collision is not resolved based at least in part on one or more symbols of the multiplexed uplink message overlapping at least partially with the first downlink message, and wherein the one or more symbols are associated with the first uplink message.

18. The half-duplex UE of claim 16, wherein the second SBFD collision is resolved based at least in part on one or more symbols of the multiplexed uplink message being exclusive of the first downlink message, and wherein the one or more symbols are associated with the second uplink message.

19. A method for wireless communications at a half-duplex user equipment (UE), comprising:
receiving a configuration message indicating one or more sub-band full-duplex (SBFD) symbols for a network entity, wherein each SBFD symbol of the one or more SBFD symbols comprises one or more uplink sub-bands and one or more downlink sub-bands;
receiving one or more control messages scheduling a plurality of messages during an SBFD symbol, the plurality of messages including one or more uplink messages, one or more downlink messages, or both, wherein the plurality of messages are associated with a plurality of SBFD collisions within the SBFD symbol, the plurality of SBFD collisions associated with a plurality of SBFD collision types comprising any combination of a first SBFD collision type associated with at least a first subset of the plurality of messages overlapping at least partially outside of the one or more downlink sub-bands or the one or more uplink sub-bands, a second SBFD collision type associated with at least a second subset of the plurality of messages associated with a same transmission direction overlapping in a time domain, a third SBFD collision type associated with at least a third subset of the plurality of messages associated with different transmission directions overlapping in the time domain, and a fourth SBFD collision type associated with at least a fourth subset of the plurality of messages being associated with a first transmission direction different than a second transmission direction associated with the SBFD symbol; and
communicating, via the SBFD symbol, at least a fifth subset of the plurality of messages based at least in part on resolving the plurality of SBFD collisions in accordance with an SBFD collision type priority order.

20. A non-transitory computer-readable medium storing code for wireless communications, the code comprising instructions executable by one or more processors to:
receive a configuration message indicating one or more sub-band full-duplex (SBFD) symbols for a network entity, wherein each SBFD symbol of the one or more SBFD symbols comprises one or more uplink sub-bands and one or more downlink sub-bands;
receive one or more control messages scheduling a plurality of messages during an SBFD symbol, the plurality of messages including one or more uplink messages, one or more downlink messages, or both, wherein the plurality of messages are associated with a plurality of SBFD collisions within the SBFD symbol, the plurality of SBFD collisions associated with a plurality of SBFD collision types comprising any combination of a first SBFD collision type associated with at least a first subset of the plurality of messages overlapping at least partially outside of the one or more downlink sub-bands or the one or more uplink sub-bands, a second SBFD collision type associated with at least a second subset of the plurality of messages associated with a same transmission direction overlapping in a time domain, a third SBFD collision type associated with at least a third subset of the plurality of messages associated with different transmission directions overlapping in the time domain, and a fourth SBFD collision type associated with at least a fourth subset of the plurality of messages being associated with a first transmission direction different than a second transmission direction associated with the SBFD symbol; and
communicate, via the SBFD symbol, at least a fifth subset of the plurality of messages based at least in part on resolving the plurality of SBFD collisions in accordance with an SBFD collision type priority order.
